(19) United States
(12) Patent Application Publication
(10) Pub. No.: US 2005/0008904 A1
(43) Pub. Date: Jan. 13, 2005

(54) Regenerative fuel cell technology

(76) Inventor: Galen J. Suppes, Columbia, MO (US)

Correspondence Address: Galen J. Suppes, The Department of Chemical Engineering, W2028 Engineering Bldg, East, Columbia, MO, 65211, US

(21) Appl. No.: 10/889,448

(22) Filed: Jul. 10, 2004

Related U.S. Application Data
(60) Provisional application No. 60/486,280, filed on Jul. 11, 2003.
(60) Provisional application No. 60/519,870, filed on Nov. 13, 2003.
(60) Provisional application No. 60/541,178, filed on Feb. 2, 2004.

(51) Int. Cl. H01M 16/00; H01M 8/04; H01M 10/46; H01M 8/18; H01J 7/34

(52) U.S. Cl. 429/9; 429/61; 320/101; 429/22; 429/21; 429/25

(57) ABSTRACT

For a mobile fuel cell system a narrow-gap modular approach allows reforming to be performed in the same architecture as the fuel cell. A regenerative fuel cell operates much like a battery using electrical power to produce hydrogen and oxygen. The preferred mode of using the regenerative fuel cell is as a battery charger since this application is able to use a much smaller fuel cell than is required to power the vehicle. A novel equilibrating tank between the electrolysis oxygen and hydrogen tanks allows pressurized oxygen and hydrogen to be used without mechanical compression equipment.

### CROSS REFERENCE TO RELATED APPLICATIONS

A This application claims priority of the following U.S. Provisional Patent Applications: Ser. No. 60/486280, filed Jul. 11, 2003; Ser. No. 60/519870, filed Nov. 13, 2004, and Ser. No. 60/541178, filed Feb. 2, 2004.

### BACKGROUND OF THE INVENTION

1. Field of Invention

This invention is in the area of fuel cell technology. Specifically, the invention is on a high pressure regenerative fuel cell system that operates like a battery and the use of this regenerative fuel cell system in a plug-in hybrid electric vehicle.

2. Description of Prior Art

Use of the fuel cell as a battery charger in a plug-in hybrid electric vehicle is a novel approach. No similar art was located.

Patent application 20040074040 of J. J. Duffy et al. uses a high pressure electrolyzer and pressure equalization system. The differential pressure controls of the system of Duffy et al are not necessary with the embodiments of this invention. The priority of this invention predates the publication of the Duffy et al application.

The preferred embodiments of this invention use higher oxygen and hydrogen pressures to reduce needed catalyst loading levels. The higher pressures allow operation at higher temperatures without dehydration. The purity of both the hydrogen and oxygen also impact fuel cell power output. Air has an oxygen concentration near 21 (mol) %. Higher oxygen concentrations increase the power output from a fuel cell through multiple mechanisms. One mechanism of increasing output is by providing a higher activity of oxygen on the cathode side of the fuel cell that increases the Gibbs Energy change associated with the conversion to water. A second mechanism to increase power output is to increase the driving force for the combination of oxygen, hydrogen, and electrons on the cathode side of the fuel cell. A third mechanism to increase the power output is to decrease the amount of cathode-side purge of “inert” gases (like nitrogen) which in turn reduces the amount of oxygen that is also purged from the system. Especially when oxygen is compressed to high pressures, it is quite costly to discharge unreacted oxygen from the fuel cell.

Pure oxygen can be used to increase the power output of a fuel cell up to about double the power output of the fuel cell operated with air at the same conditions. Also, the cost of compressing a specified quantity of oxidant as oxygen is less than the cost for compressing air. The preferred embodiments use compressed oxygen, rather than ambient air, to increase the fuel cell power output.

In conventional approaches to fuel cell design, reduced catalyst costs associated with operating the fuel cell at higher pressures are diminished by increasing compression costs (for compressing oxygen or air and for compression hydrogen). Furthermore, the static pressures of conventional fuel cell designs are limited by the pressures the membranes can contain. The embodiments of this invention overcome the diminishing impacts of compression for high pressure fuel cell operation. For the Plug-In system, hydrogen and oxygen are produced at the same pressures at which they are consumed; therein, any electrochemical penalty associated with producing these gases at high pressures is partially recuperated by using the compressed hydrogen and oxygen at essentially the same pressure at which they were generated. The preferred mode of operation is the Plug-In mode where hydrogen and oxygen are produced on the vehicle of application, and so, auxiliary operation involving compressing ambient air (or lower pressure oxygen) has a lessened impact on the overall efficiency. To advantage of the embodiments of this invention, high pressures are used to reduce catalyst costs to a greater extent than with conventional systems.

The embodiments of this invention are designed such that the membranes do not contain the pressure; rather, the membranes need only contain a pressure difference between the cathode and anode sides of the membranes. This pressure difference is contained independent of the static pressure of the system. To advantage of the embodiments of this invention, higher pressures are used without increased structural constraints on the membranes.

When operating in the non-preferred mode of using atmospheric air as a source of oxygen for the fuel cell, the embodiments of this invention have means to reduce the compression costs. The preferred means of reducing the compression costs is to separate oxygen from air and compress and oxidant stream that has a higher concentration of oxygen than is available in the air. The preferred means of separating oxygen from nitrogen (in the air) is a membrane air separator. To advantage of the embodiments of this invention, the costs of compressing oxidants to high pressures are reduced.

The use of stored oxygen that is both compressed and more pure than available in air increases the maximum instantaneous power output of the fuel cell system since the fuel cell system can selectively expend energy for compression and purification at times with propulsion/acceleration needs are low. Therefore, this compressed, purified oxygen is a means for energy storage. Furthermore, this means of energy storage can be used with substantially lower irreversibilities than those associated with operations like charging and discharging batteries. The energy losses associated with air separation and compression of oxygen occur whether the oxygen is used immediately or stored. To advantage of the embodiments of this invention, oxygen storage is used as an improved means of energy storage.

When plugged in, the fuel cell system uses electrolysis to produce and store hydrogen and oxygen on the vehicle. Electrical power is also preferably used to separate oxygen form air, compress the oxygen-rich stream, and store the oxygen-rich gas. To advantage of the embodiments of this invention, this significantly increases the power available from the fuel cells when operating beyond that range provided from hydrogen and oxygen generated from Plug-In operation.

Air of the cathode purge stream is preferably recycled back to the air separator as a second oxygen source feed stream.

This cathode purge stream is fed to and mixed with the air separator by a method that minimizes the loss in availability associate with this mixing process. Recycle in this manner allows the pressure and composition of the cathode recycle stream to be optimized to produce higher fuel cell power output than the alternative of purging the cathode purge stream to surrounding air. Specifically, the improved optimized cathode purge streams are higher in pressure and oxygen concentration. To advantage of the embodiments of this invention, recycle of the cathode purge stream to the air separator significantly increases the power available from the fuel cells by operating at an overall higher average oxygen concentration in the gases on the cathode sides of the fuel cells.

At least two groupings of fuel cells in the fuel cell stack are arranged is series in the preferred embodiments of this invention. To advantage of the embodiments of this invention, this series configuration allows for higher overall average hydrogen and oxygen concentrations in the fuel cell stack. To the advantage of the embodiments of this invention, this series configuration allows the group or groups that receive oxidant and fuel having higher concentrations to use lower catalyst loadings than if these group or groups were to operate at oxidant and fuel compositions consistent with the purge gas concentration of the groups operating at lower oxidant and fuel compositions.

By operating at higher pressures, dehydration of the membranes is postponed to higher temperatures-as a function of the vapor pressure of water. These higher temperatures increase the rate constants associated with specific catalysts. To advantage of the embodiments of this invention, less expensive catalysts can be used to provide the majority of needed power output.

### SUMMARY OF INVENTION

An improved fuel cell power system using an air separator to supplement a stored electrolysis oxygen supply consisting of a pressurized regenerative fuel cell capable of producing hydrogen through hydrolysis of water and producing electrical power through electrochemical reactions of oxygen and a fuel, an electrolysis oxygen tank capable of storing between 0.2 and 100 kilograms of oxygen, an air-separated oxygen tank capable of storing between 0.2 and 100 kilograms of oxygen, an air separator capable of separating air into at least one oxygen stream having a purity of at least 50 wt % oxygen, a hydrogen storage tank, a liquid fuel storage tank containing a liquid fuel, and a control means that directs the utilization of at least 70% of the stored hydrogen and stored electrolysis oxygen before switching to the use of air-separated oxygen and liquid fuel where the pressurized regenerative fuel cell is capable of operating at pressures greater than 5 bars of pressure.

An alternative embodiment is a plug-in electric vehicle with a fuel cell battery charger that uses an engine battery, and fuel cell in combination to provide power to the vehicle. The engine provides backup power for longer distance travel. For shorter distances after recharging the battery and hydrogen/oxygen tanks, the fuel cell and battery work in combination to provide both range and power. The advantage is that a small fuel cell allows for high ranges without a large number of batteries while the batteries provide for high power output without a large fuel cell. The combination of the small fuel cell used as a battery charger and the batteries is less expensive than a system comprised of fuel cells alone or batteries alone.

### BRIEF DESCRIPTIONS OF DRAWINGS

FIG. 1. Illustration of equilibrating tank system used with siphon reboiler.

FIG. 2. Illustration of equilibrating tank system on plug-in fuel cell hybrid electric vehicle.

FIG. 3. Block flow diagram of fuel cell system with stored hydrogen and oxygen used to increase power output of fuel cells.

FIG. 4. Schematic diagram of fuel cell were gas flow in fuel cell displaces liquid in the fuel cell.

FIG. 5. Block flow diagram illustrating conventional design approach.

FIG. 6. Thin-gap approach to design also referred to as narrow-gap.

FIG. 7. Illustration of narrow gap module assembly.

FIG. 8. Port network in module that eliminates need for most pipefitting.

FIG. 9. Method of mixing using plates.

FIG. 10. Further illustration of conventional and thin-gap approaches to design.

FIG. 11. Illustration of modular conversion.

FIG. 12. Illustration of catalysis plates.

FIG. 13. Illustration of fin option on plate and section of module having complete set of unit operations comprising a process.

FIG. 14. Illustration of module showing entrance and exit locations of several complete processes located within the module.

FIG. 15. Illustration of catalyst on plates.

FIG. 16. Method of using seal around port to restrict access for internal manifolding.

FIG. 17. Method of incorporating fins into modular design.

### DESCRIPTION OF PREFERRED EMBODIMENTS

The Components of Fuel Cell Embodiments: In a fuel cell system that produces electrical power through electrochemical reactions of oxygen and a fuel, the fuel cell system includes at least one fuel cell stack. The fuel cell stack is enclosed in a high pressure containment such as a pressure vessel. The fuel cell system is comprised of at least: a fuel cell stack, an oxidant entrance and a fuel entrance, media (such as membranes or salt bridges) substantially permeable to the transport of ions through said media/membrane while being substantially impermeable to the transport of electrons, each single said medium having an anode side and a cathode side, cathodes contacting the cathode sides of the membranes, anodes contacting anode sides of the membranes, and a circuit connected to both the cathode and anode capable of conducting electrons but substantially impermeable to the transport of ions. Both the cathode and anode have catalysts that promote reactions involving the release or capture of electrons. When the oxidant functionally goes to the cathode side of the fuel cell, the oxidant entrance is also the cathode entrance. When the fuel functionally goes to the anode side of the fuel cell, the fuel entrance is also the anode entrance.

Additional components of the fuel cell system include but are not limited to: a cathode side exit for discharging gases such as nitrogen that accumulate on the cathode side of the fuel cell said exiting gases referred to as a cathode purge stream, an anode side exit for discharging gases such as carbon dioxide that accumulate on the anode side of the fuel cell said exiting gases referred to as an anode purge stream, a fuel tank for storing fuel, and an oxidant tank.

In embodiments using PEM fuel cells, the fuel tank is a hydrogen tank. The oxidant tank typically stores oxygen produced by electrolysis. Oxygen may also be produced and stored by an air separator. When oxygen is produced by both electrolysis and an air separator, the preferred embodiments of this invention have a first oxygen tank for electrolysis oxygen and a second oxygen tank for oxygen from the air separator.

Additional components of the most preferred embodiments of this invention include but are not limited to: an electrolyzer capable of converting water to hydrogen and oxygen, the preferred electrolyzer is a regenerative fuel cell (commonly called a reversible fuel cell) that can produce electrical power if supplied with a fuel and oxidant and can produce hydrogen and oxygen if supplied with water and electrical power, a plug-in to connect the fuel cell system to electrical power from grid electricity (e.g. the 120 Volt AC electricity available in residences), a water tank capable of storing enough water to meet feed requirements for the electrolyzer, an air separator capable for providing oxygen of between 40% and 99.5% which supplements the oxygen prepared by electrolysis means., a separation compressor capable of compressing an oxidant containing stream to provide a driving force for separating oxygen from air, a controller capable of identifying and controlling parameters that select fuel source and fuel cell operating conditions to meet power output requirement of the fuel cell stack, a controller algorithm that calculates the power output requirement of the fuel cell stack, an oxidant entrance compressor capable of compressing oxidant up to the specified fuel cell pressure, and a fuel entrance compressor capable of compressing gaseous fuel to the specified fuel cell pressure.

Additional components of the most preferred embodiments of this invention include but are not limited to: a reforming system capable of converting a supplementary fuel such as ethanol, biodiesel methanol, natural gas, gasoline, or diesel to hydrogen suitable for use by a fuel cell and a supplementary fuel tank with means to refill the supplementary fuel tank.

In the alternative embodiment referred to as a plug-in electric vehicle with a fuel cell battery charger (PEV-FCS) that uses an engine, battery, and fuel cell in combination to provide power to the vehicle. The engine provides backup power for longer distance travel—this is referred to as the backup ICI engine. The fuel cell provides insufficient power to make the vehicle go faster than about 3 to 30 miles per hour and is insufficient by itself—this fuel cell is referred to as a fuel cell battery charger because its true value is related to its ability to charge the batteries when the vehicle is not requiring substantial power for travel or auxiliary operation. In the PEC-FCS, the battery pack is a relatively standard battery pack similar to what would be found on a hybrid electric vehicle or plug-in hybrid electric vehicle.

The most preferred embodiment of this invention is a fuel cell system on a vehicle with a plug-in having a connection side capable of being connected to grid electricity (preferably 120 volt AC). When the vehicle is stationary, the fuel cell system may be plugged into grid electricity to recharge hydrogen supplies, oxygen supplies, batteries, capacitors, or other devices on the vehicle capable of storing energy. When in transit, the vehicle's respective fuel cell system may use the stored energy to provide propulsion energy needs.

When recharging, the plug-in connects grid electricity to the electrolyzer therein providing electrical power to the electrolyzer. The electrolyzer produces hydrogen and oxygen and stores the hydrogen and oxygen in a hydrogen tank and a first oxygen tank at pressures up to about 350 bar. The plug-in also connects the grid electricity to an air separator that is preferably comprised of air separation membranes and at least one compressor. The air separator selectively removes oxygen from air to form a separator oxygen gas having a purity of about 98%, compresses the separator oxygen gas, and directs the compressed separator oxygen gas to a second oxygen tank for storage at pressures up to about 350 bar.

When in transit, the preferred fuel and oxidant are hydrogen from the hydrogen tank and oxygen from the first oxygen tank. The hydrogen tank and first oxygen tank are connected to the anode entrance and cathode entrance of the fuel cell stack, respectively. The fuel cell is operated at about the same pressure as the pressure in the hydrogen tank and first oxygen tank when the pressures in these tanks are sufficient to meet power output requirements as determined by the controller. If the pressure in the hydrogen and first oxygen tanks becomes insufficient to provide the power output requirements, the oxidant entrance compressor and fuel entrance compressor increase pressure to meet power output requirements. Hydrogen and oxygen are consumed from the hydrogen tank and first oxygen tank until the pressure in these tanks are sufficiently low that they are unable to fuel the fuel cell stack as necessary to meet the power output requirements. Preferably, the hydrogen tank and the second oxygen tank are sized and pressure rated to provide at least 20 miles of range and often up to 40 miles of range. For example, the 20 mile range might be a standard feature on the vehicle and the 40 mile range might be an option.

When the hydrogen tank and first oxygen tank are no longer able to supply sufficient fuel and oxidant to meet requirements, the controller switches the fuel and oxygen sources. Valving and piping methods known in the science are used to switch and deliver hydrogen from the reforming system to the anode entrance and separator oxygen gas to the cathode entrance. To provide hydrogen from the reformer to the fuel cell stack in time to replace the hydrogen from the hydrogen tank, the controller starts the reformer system when the amount of hydrogen in the hydrogen tank is depleted to about 20% of full. Up to 100% of the separator oxygen gas may be supplied from the second oxygen tank, up the 100% of the separator oxygen may be supplied directly from the air separator, and the ratio of oxygen supplied from the second tank to that supplied directly from the separator is controlled by the controller. This ratio is an important control parameter used by the controller to manage power output and the level of oxygen in the second oxygen tank.

When an increased power output from the fuel stack is required, the amount of oxygen needed by the fuel cell increases about proportionally to the increase in power demand. A method for meeting this increase in separator oxygen demand is to increase the ratio of separator oxygen supplied from the second oxygen tank. Controller selection of this ratio is dependent upon many factors including the amount of oxygen in the second oxygen tank and the impact of operating conditions on the fuel cell efficiency.

The performance curves of fuel cells are characterized by high efficiencies at low amperage fluxes (A/cm2). The efficiencies decrease with increasing amperage fluxes until a condition of maximum power output. Fuel cells are typically not operated at amperage fluxes greater than that corresponding to maximum power output because both efficiency and power output decrease at higher amperage fluxes.

The following table summarizes how the preferred fuel cell embodiments of this invention operate:

| | | | Level | | |
|---|---|---|---|---|---|
| Approximate | Approximate | Approximate | of | Efficiency | |
| Hydrolysis | First | Second | Propuls | (poor, | |
| Hydrogen | Oxygen | Oxygen | ion | OK, | |
| Tank | Tank | Tank | Power | good, | |
| Level | Level | Level | Demand | excellent) | Comments |
| >20% | Same | Full | Low- | E | This is the most common mode of operation and the most |
| Full | as | | High | | efficient mode of operation |
| | hydrogen | | | | |
| Empty | Same | >60% | Low- | G-E | Fuel cell is operating from reformed hydrogen and oxygen that |
| | as | Full | High | | has been separated from air. Control algorithm emphasizes |
| | hydrogen | | | | efficient use of stored oxygen. |
| Empty | Same | 30%-60% | Low | G | Fuel cell is operating from reformed hydrogen. Since the tank |
| | as | Full | | | has room for additional oxygen storage, fuel cell efficiency is |
| | hydrogen | | | | slightly compromised to provide extra power output used to |
| | | | | | separate and store more oxygen in the second oxygen tank than |
| | | | | | is consumed. The pressure of oxygen in the second oxygen tank |
| | | | | | increases. Low power output and high efficiency modes of fuel |
| | | | | | cell operation are used at times when vehicle is parked to |
| | | | | | increase levels of stored oxygen. |
| Empty | Same | 30%-60% | Moderate | O-G | Fuel cell is operating from reformed hydrogen. The fuel cell |
| | as | Full | | | power output is - designed to maintain operation at this level for |
| | hydrogen | | | | sustained periods of time without the net consumption of oxygen |
| | | | | | in the second tank. The Important design condition to meet fuel |
| | | | | | economy targets. Low power output and high efficiency modes |
| | | | | | of fuel cell operation are used at times when vehicle is parked to |
| | | | | | increase levels of stored oxygen. |
| Empty | Same | 30%-60% | High | O | Fuel cell is operating from reformed hydrogen. More stored |
| | as | Full | | | oxygen is being used than is being generated decreasing the |
| | hydrogen | | | | pressure of oxygen in the second oxygen tank. Power output is |
| | | | | | sufficiently high so as not to warrant maximum power output at |
| | | | | | the expense of efficiency. Low power output and high efficiency |
| | | | | | modes of fuel cell operation are used at times when vehicle is |
| | | | | | parked to increase levels of stored oxygen. |
| Empty | Same | <30% | Low- | P | Maximum power output of the fuel cell may be required to make |
| | as | Full | Pressure | | sure stored - oxygen levels do not go below about 10% of full. |
| | hydrogen | | | | The control algorithm may restrict power output to assure stored |
| | | | | | oxygen levels do not go below 10% of full. The controller may |
| | | | | | decrease maximum power available for propulsion to sustain |
| | | | | | operation at an overall average acceptable level. Fuel cell and air |
| | | | | | separator operate at all times even when vehicle is parked to |
| | | | | | increase levels of stored oxygen. High power for acceleration |
| | | | | | may not be available. Important design condition toward |
| | | | | | specifying maximum fuel cell power output. |

For the data of this table, propulsion power output is only a part of the total fuel cell power output. Depending upon the mode of operation, power may be used to separate, compress, and store oxygen in the second oxygen tank. The embodiments and control algorithm (as summarized in above table) purify and compressed oxygen that is stored in the second oxygen tank, this stored oxygen has stored energy both due to its potential energy (from high pressure) and the stored oxygen's ability to provide the fuel cell system with extra oxygen at times of high power demand.

Typically, the oxygen in the first oxygen tank is sufficient to travel 20-40 miles, and an addition 40-100 miles can be attained before the second oxygen tank is depleted to about 30% full levels. After this 60 to 140 miles, the second oxygen may be depleted to less than 30% with poor performance possible as a result of the controller operating the fuel cell system to prevent further depletion of oxygen; however, the preferred applications for this vehicle will have less than 5% of travel at these conditions. Furthermore, the poor performance will predominantly only limit the extent to which high acceleration is available, and this impact will only be realized by those drivers who rely on high acceleration during travel.

Preferably, air separator oxygen is used by the reformer. Preferably, the reformer is operated at the same pressure as the fuel cell stack, and the fuel cell stack is operated at either the pressure of the second oxygen tank or a higher pressure provided by the cathode entrance compressor as required by the controller to meet power demands. Preferably, the cathode entrance compressor provides the needed pressure boost for the oxygen going to the reformer as well as the oxygen going to the cathode entrance.

High Pressure Operation and Associated Embodiments: The preferred embodiments of this invention use hydrogen and oxygen pressures to reduce the costs of catalysts on the anodes and cathodes. The preferred operating pressures are between 3 and 700 bar (absolute pressure). The more preferred operating pressure is between 50 and 400 bar. The most preferred operating pressure is between 75 and 300 bar.

The media/membrane that separates the anode from the cathode must maintain a pressure difference between the anode and cathode sides. The preferred pressure difference is between −3 and 3 bar. The more preferred pressure difference is between −1 and 1 bar. The most preferred pressure difference is between −0.1 and 0.1 bar.

With static pressures on the cathode and anode sides of the fuel cell typically in excess of 100 bar, a control means or design feature is necessary to prevent the rupture/destruction of the media/membrane. The preferred control means is a valve configuration consisting of at least one valve on the cathode side exit and at least one valve on the anode side exit where one valve is a flow control valve used to maintain the flow rate of either the oxidant or fuel purge as specified by the controller and the other valve is a differential pressure valve used to control the differential pressure between the cathode and anode sides of the fuel cell. Preferably the differential pressure valve is based on a mechanical mechanism such as a diaphragm with one side contacting anode side gases and one side contacting cathode side gases where this diaphragm opens or closes the differential pressure valves based on movement of the diaphragm in response to differential pressures.

Increased pressures for the gaseous fuel and the gaseous oxygen decrease the amount of catalysts needed and thereby decrease the fuel cell cost.

Equilibrating Tank Configuration for High-Pressure Fuel Cell—In a fuel cell operated at high pressures, an improved means of maintaining small pressure differentials between the different sides of the electrolyte (membrane, or membrane electrode assembly) includes operating the fuel cell at the same pressure as the stored hydrogen and oxygen where the hydrogen and oxygen storage tanks are connected by a liquid-continuous phase and the liquid flows from one tank to the other to equalize the pressure between tanks.

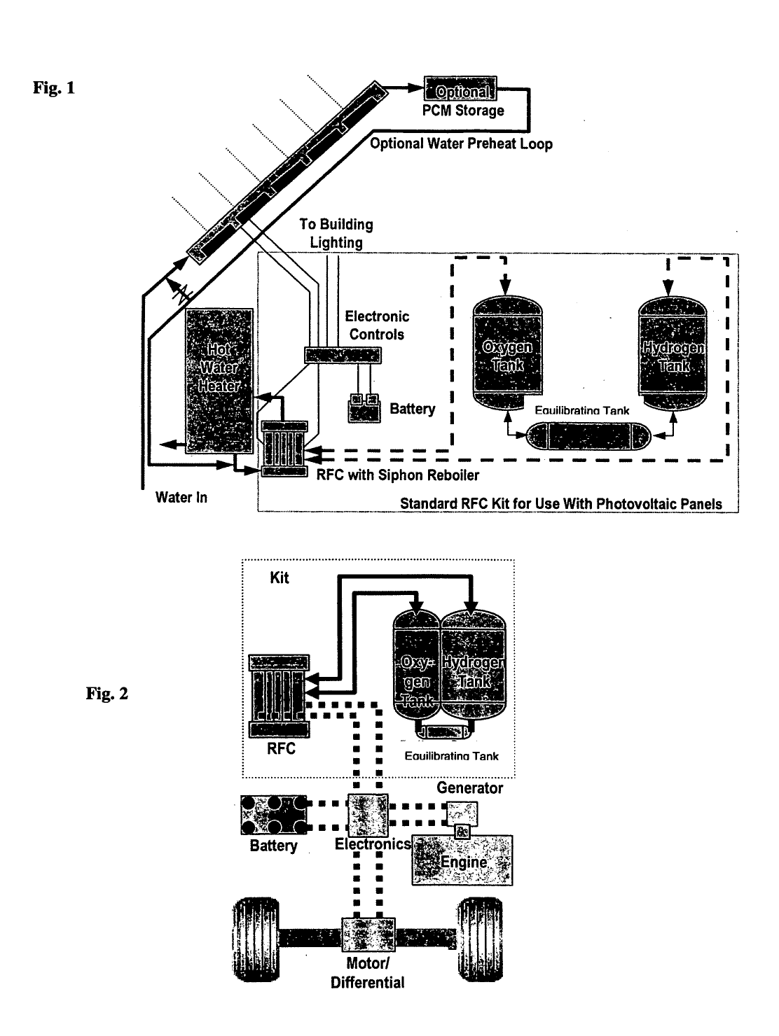

This invention is useful with co-generative regenerative fuel cell systems with solar panels to provide electrical power needs and heating. Novel and valuable features of preferred co-generative regenerative fuel cell systems include: 1) high-pressure electrolysis that alleviates the needs for compressors, 2) a siphon reboiler cogeneration configuration to provide water and space heating, 3) preheating of water in coils coupled with the photovoltaic samples to extend the ability to provide water and space heating, and 4) use of Phase Change Material (PCM) to store the heat. In particular, in Phase II we will develop a showcase demonstration of solar power utilization that has highly favorable commercialization potential. FIG. 1 illustrates many of these features.

The equilibrating tank is illustrated by FIGS. 1 and 2.

Preferably, one end of the equilibrating tank is connected to the bottom of the hydrogen tank while the other end is connected to the oxygen tank. Preferably, the volume of the equilibrating tank is from 0.2% to 40% of the volume of the oxygen tank. More preferably, the volume of the equilibrating tank is between 2% and 20% of the volume of the oxygen tank. For smaller volume equilibrium tanks, the tank is preferably a coil of tubing with plug-type fluid flow that limits the amount of hydrogen-saturated water that enters the oxygen tank and the amount of oxygen-saturated water that enters the hydrogen tank.

Preferably, float-activated plugs are in both the oxygen and hydrogen tanks. When liquid levels are low, the float-activated plug prevents the further flow of liquid from that tank into the equilibrating tank.

The liquid is preferably water. This water is optionally the electrolysis water. For electrolysis to occur, a pump must flood the oxidant (cathode) side of the regenerative fuel cell (not shown by Figs.). This pump is located on a line between the equilibrating tank and a manifolding system that is connected to the bottom of all oxidant sides of the regenerative fuel cell.

This water control system includes a method for draining the oxidant sides of the fuel cell when switching from electrolysis to power generation modes of operation in the regenerative fuel cell. One method of draining to locate the regenerative fuel cell at a higher location than the equilibrating tank where a valve that by-passes the pump is opened to allow the water to drain from the regenerative fuel cell to the equilibrating tank. An alternative arrangement uses a 3-way valve that allows the pump to pump liquid from the regenerative fuel cell back to the equilibrating tank.

Applications with Wind or Solar Power—A RFC has about the same kW rating for hydrogen/oxygen production as for electrical power generation from stored hydrogen/oxygen. Under this constraint, the maximum attainable power output to total stored energy ratio in a 24-hour period is obtained with constant production of hydrogen/oxygen for 12 hours and constant electrical power production for 12 hours—this translates to a ratio of 1/12 h-1. For days with 8 hours of sunlight, this can reduce to 0.125 h-1 which includes 8 hours of hydrogen production, 6 hours of more-intensive use of the stored power in the evening and early morning, and 10 hours of minimal use during the night. High on-line times for the fuel cells of this system provide for a relatively steady supply of waste heat.

In addition, it is desirable in remote power applications for stored energy reserves to last for multiple days without wind or usable solar power. Here, for two days without wind/sun, the cost of a battery pack storage system would go from $6,000 to $36,000 while the cost of a RFC system would increase moderately to about $2,400 to allow for larger hydrogen/oxygen storage tanks and these tanks could be refilled for prolonged operation. It should be noted that once the energy reserve (either a battery pack or stored hydrogen/oxygen) is fully depleted, it could take weeks to replenish the reserves based on the accumulation of excess energy for each 24-hour period.

A disadvantage of fuel cells as compared to batteries is the lower efficiency of fuel cells. Batteries operate at about 80% efficiency while fuel cells operate at about 60% efficiency. However, waste heat can become an advantage of fuel cells because fuel cells can operate well at temperatures in excess of 80° C. At these temperatures, the RFC's co-generated heat can be used for water and space heating. Potentially, this heat could be used for air conditioning (e.g. ammonia cycle). For regenerative systems designed to operate most of the 24-hour day, this waste heat can be used to great advantage. For solar systems, the prospect of incorporating hot water preheating coils into the photovoltaic cells with waste heat topping off the heat provided by the photovoltaic solar cells is intriguing and potentially applicable to large commercial and residential markets where natural gas heating is not available. Remote applications also provide a major commercial opportunity.

Because of the adverse impacts of pressure drops and buildup of inert nitrogen with air-based fuel cells near-atmospheric conditions, gas distribution requires special attention. At higher pressures with pure hydrogen/oxygen distribution is considerably less of a problem. In theory, only a gravity-fed water trap would be necessary.

In practice, convective flow can be used to reduce cathode-side pore flooding. Even gas distribution is less important so long as bipolar plate design prevents formation of stagnant areas. At high pressures, restrictive orifices can be used at distributors to assure relatively even distributions of gases without inducing significant available energy losses. Since flow is related to changes in pressures and available energy of a gas is related to the ratio of pressures, the available energy losses resulting from the use of orifices used on high-pressure streams in minimal.

In fuel cells, gas distribution is closely coupled with heat removal. When operating at high water vapor pressures, convention will reduce the accumulation of water vapor that can dilute the oxygen. At higher flow rates, the heat capacity of the oxygen/hydrogen can also remove much of the heat.

Typically, channels in bipolar plates can be used for coolants. During high-pressure operation, the cost of these channels can be high if the coolant is at near-atmospheric pressure.

Our preferred approach includes the following:

Operation of the fuel cell at the pressures of the gas storage even if this increases the cost of heat removal—this will avoid costly compression equipment that would otherwise be necessary to compress electrolysis gases.

Use of convective gas flow for heat transfer from 2 of every 3 anode/cathode compartments.

Locate water-cooling channels in every 6th bipolar plate evenly spaced throughout the stack.

Connection of anode compartments in series for gas flow such that hydrogen and oxygen flow, each passes through three separate anode/cathode compartments prior to leaving the stack. Flows will exit the stack at compartments next to the bipolar plates with heat removal. Flows will enter the stack with distribution starting at the center of the compartments furthest from the bipolar plates with heat removal.

Electrolysis/product water will be circulated at the pressure of the fuel cell through the bipolar plates with heat removal. This water will be collectively cooled with air or water in a heat exchanger that is separate from the fuel cell stack.

This approach to system design will substantially reduce cost penalties related to gas distribution and heat removal at high pressures.

It is important to distinguish between the static operational pressure of a RFC and the pressure differential across the PEM.

Static pressure limits are primarily determined by the end plates of the fuel cells stack and the pressure rating of the parameter seals. The pressure differential is across the membrane and is limited to several PSIG due to the limited strength of the membrane. For high-pressure operation of a fuel cell, differential pressure must be actively control, preferably in combination with passive control design features such as operating the stack at the same pressures as the storage tanks and using a hydrogen storage tank that is approximately twice the volume of the oxygen storage tank.

A novel differential pressure regulator will control the differential pressure-the regulator will be activated by anode-cathode pressure differences and control a valve between the oxygen and hydrogen tanks. This valve will allow water to flow from one tank to the other to balance pressure-as necessary, a buffer equilibrating tank (see FIG. 1) between the two would control the flow soluble oxygen/hydrogen between tanks. Technically, the valve is not needed, but the regulator and float valves (stopping gas flow) are good safety measures.

FIG. 2 illustrates a condensed equilibrating tank that equilibrates the pressure between a hydrogen and oxygen tank on a vehicle.

Use of high-pressure (up to 5000 psig) RFCs will solve problems associated with the lack of a hydrogen infrastructure. Use of fuel cells in combinations with batteries on HEVs will reduce the RFC kW rating to about 2.0 and the FC cost to <$1,000 as compared to $15,000 for a 50 kW fuel cell to replace the gasoline engine.

In Battery Electric Vehicles (BEV) the cost of the power system can be cut in half. When used with solar or wind energy in buildings, the co-generated heat which would be about 64% (for two conversions: 64%=1−[60%]²) of the electrical power routed to the RFC and can be used to provide hot water, space heating, and air conditioning.

High-pressure RFC systems have improved economics because: 1) producing hydrogen and oxygen at storage pressures avoids most losses associated with compression and eliminates the costly compressor from the system, 2) operating at oxygen/hydrogen storage pressures up to 5,000 psig provides increased power output as compared to atmospheric pressure operation, 3) using pure oxygen as the oxidant doubles the power output as compared to using air an a oxidant, and 4) operating as either an electrolyzer or a fuel cell for most of a 24-hour day maximizes on-line times. For commuters who travel 0-15 miles to work in RFC HEV vehicles, the battery provides the high power output for the commute from home to the office. While at work, the fuel cell charges the batteries for the commute home (i.e. “portable battery charge”). At night, grid electricity is used to charge batteries and produce hydrogen/oxygen on board the vehicle. Economics are GOOD! The significant market opportunity for fuel cells is in applications competing with batteries where the [power]:[stored energy] ratio is low <0.25 h⁻¹). Potential applications include 1) replacing battery packs on vehicles and 2) storing wind or solar power.

An improved fuel cell power system for use with a vehicle. The improvement is a tank capable of holding 0.15 to 0.5 kilograms of hydrogen storage and a tank capable of holding 1.2 to 4 kilograms of oxygen storage, an electrolysis ability to convert water to this stored oxygen and hydrogen, and a control strategy that uses the stored hydrogen and oxygen to increase the power output of a fuel cell stack to a level greater than that which is possible when atmospheric air is supplied to the fuel cell cathode.

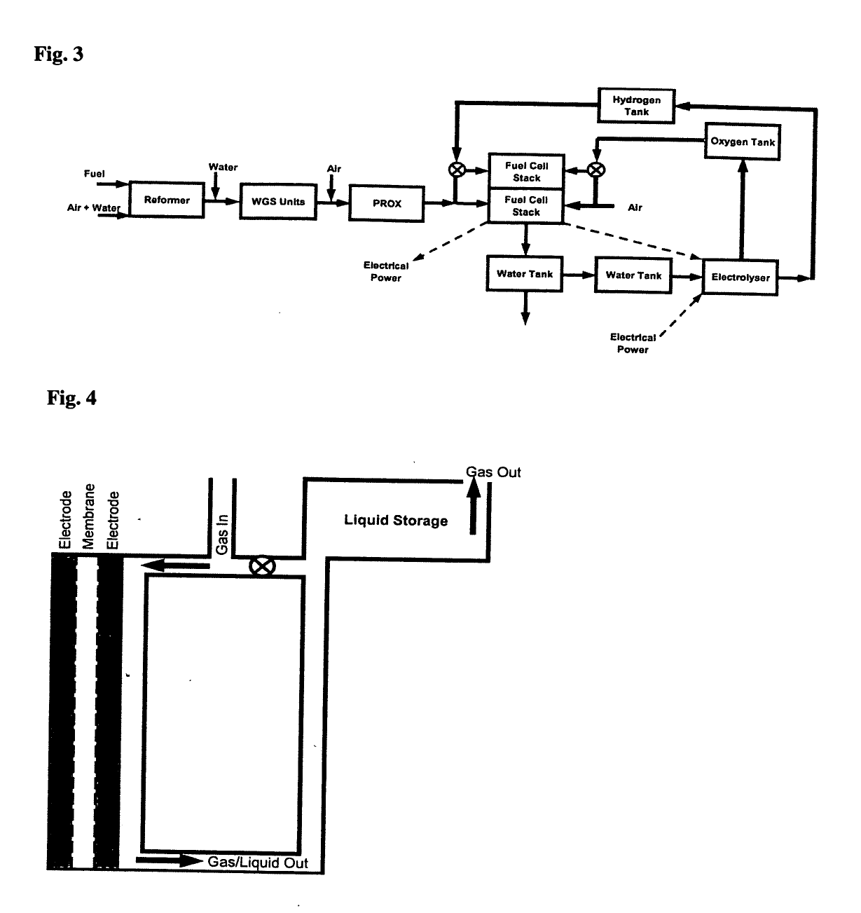

FIG. 3 illustrates the preferred embodiment of this invention. A fuel such as gasoline, diesel, or methanol is reformed in the presence of air and water to convert the liquid fuel (easily stored) to a synthesis gas in the Reformer. The synthesis gas proceeds to a water-gas-shift system with additional water optionally added to promote conversion of carbon monoxide to hydrogen in a WGS synthesis gas. WGS synthesis gas proceeds to a PROX unit where it is contacted with sufficient oxygen (from air) to convert the carbon monoxide to carbon dioxide to achieve carbon monoxide levels sufficiently low as to avoid poisoning of the catalyst in the hydrogen fuel cell therein producing a PROX synthesis gas. The PROX synthesis gas proceeds to the fuel cell where it and air react in the constraints of the fuel cell to produce electricity. The power output in this mode of operation is referred to as the Standard Power Output or SPO. The SPO is will not meet the maximum power requirements of the vehicle.

The preferred embodiment has at least two valves (three-way valves as illustrated by FIG. 3) where the output of the fuel cells can be increased when the vehicle power requirement exceeds the SPO. To achieve increased power output from the fuel cell, at least part of the fuel cell stack is switched (through use of valves) from using reformed hydrogen (diluted with nitrogen and carbon dioxide) to using stored high-pressure hydrogen at the anode and from using air to used stored high- pressure oxygen at the cathode. Using stored high-pressure hydrogen and oxygen increase the power output of that portion of the fuel cell stack supplied with these reagents.

A high-pressure hydrogen tank is used to store the high-pressure hydrogen, and a high-pressure oxygen tank is used to store high-pressure oxygen. The oxygen and hydrogen are generated with an on board hydrolyser. The hydrolyser may be powered from either excess electrical power from the fuel cell or from electrical power provided by the 120 V AC electrical power grid through plug-in capabilities. In addition to providing increased power output from the fuel cells, the vehicle may operate entirely from the stored hydrogen and oxygen for a limited range (e.g. 20 miles). About 50% of all cars travel 20 miles or less in a day, and so, this plug-in hydrolysis and storage option would be capable of resulting in large portions of imported crude oil being replaced with the fuels used to produce electrical power such as coal and nuclear power.

The control strategy for the system includes running from stored hydrogen/oxygen for short trips, starting the reformer as the stored hydrogen/oxygen is depleted to about 2 to 10 miles, switching to PROX synthesis gas and air rather than stored hydrogen/oxygen when the PROX synthesis gas is ready for use, using the SPO not needed by the vehicle to generate 2-10 miles of stored hydrogen/oxygen if the stored hydrogen/oxygen becomes depleted, using stored hydrogen/oxygen to increase the power output as described it the preferred embodiment and as needed, using a battery or battery pack in addition to the hydrogen storage as an energy storage means with less capacity but greater efficiency and easier switching from a mode of storing power to providing power.

In the system of FIG. 3, onboard water is preferably maintained by condensing water from the exhaust of the fuel cell.

In the most preferred embodiment, a regenerative fuel cell stack is used to generate hydrogen/oxygen, electricity, or combination of the two by dividing tasks of the fuel cell.

The most preferred fuel cell is a proton exchange membrane (PEM) fuel cell. Alternatively other fuel cells, such as phosphoric acid fuel cells, may be used. The embodiments of this invention on the use of hydrogen to increase power output of the fuel cell hold independent of whether a Reformer-WGS-PROX system is used to produce hydrogen from stored liquid fuel. The embodiments of this invention on the use of hydrogen to increase power output of the fuel cell hold for use with a fuel cell that may be powered from stored hydrogen and an alternative fuel originating from a liquid fuel stored on the vehicle.

In the most preferred embodiment, the waste heat of the fuel cell stack is used to partially warm up the Reformer, WGS units, and PROX. Any combination of methods known in the science may be used to transfer heat to the Reformer, WGS units, and PROX including but not limited to routing of fuel cell exhaust gases from the fuel cell to these units, integrations of the units into the same module as the fuel cell, and combustion of unused hydrogen in the exhaust gases (with appropriate heat transfer) to generate higher temperature heat.

In the preferred embodiment, stored oxygen is used in the fuel cell to increase power output. Alternatively, stored oxygen may be used in the reformer rather than air. This effectively removed nitrogen from the PROX synthesis gas and will provide increased fuel cell power and reduced loss of hydrogen in the fuel cell exhaust. In this alternative embodiment, pure hydrogen or pure hydrogen and oxygen are supplied directly to the fuel cell to increase power output. The maximum amount of stored oxygen is preferably 1.5 to 6 kilograms. Excess oxygen becomes available for use with the PROX when stored hydrogen is used in combination with air to power the fuel cell.

In the preferred antifreeze fuel cell embodiment, the flow of gases to the cathode and anode sides of the fuel cell displace the mixture of water and glycol. This is preferably performed with a minimum in pressure drop.

FIG. 4 illustrates an embodiment in which a space for gas flow next to the electrode include an inlet at the top of the space for gas to enter and an exit at the bottom of the space for gas to exit. The flow of gas forces liquid from the space through the bottom exit. The flow continues to carry the liquid to a liquid trap located at a height higher than the highest portion of the fuel cell where. The gas and liquid enter the trap at the bottom of the trap reservoir and the gas exist at the top of the trap reservoir. The horizontal cross-sectional area of the trap preferably provides for a maximum gas velocity that does not exceed 2 ft/s so as to minimize the amount of liquid entrained in the gas effluent. The liquid remains in the trap so long as gas flows from the space next to the electrode of the fuel cell. When the gas flow ceases, the bottom entrance to the trap becomes a bottom exit for the liquid and the liquid drains back into the space next to the fuel cell. In this embodiment, a pressure equalizing tube and valve functionally connect the gas inlet to the gas outlet. The valve is operated to equalize pressure based on criteria indicating the fuel cell is not being used. These criteria include but are not limited a production of negligible voltage by the fuel cell and a reduction of the pressure differential across the equalizing valve below a threshold level.

Vehicular Applications—On vehicles, fuel cells and batteries have a powerful synergy, the combination can provide better performance and lower cost than batteries or fuel cells alone. Batteries are good at high power output (e.g. 50 kW) but only provide storage capacity at high cost and weight penalties. Fuel cells provide affordable capacity relative to batteries (in the form of stored hydrogen and oxygen) but have costs that are approximately proportional to power output. In RFC versions of the Plug-In Hybrid Electric Vehicle (PHEV), and Battery Electric Vehicle (BEV) a synergy is achieved by having a fuel cell (e.g. producing 2 kW) perform primarily as a battery charger throughout the day while batteries provide the high power output (e.g. 50 kW).

PHEV technology uses grid electricity to charge batteries or produce hydrogen onboard the vehicle with the first 20 to 40 miles of the day powered by this stored energy. After the stored energy is consumed a backup engine allows the vehicle to operate much like today's hybrid vehicles at fuel economies in excess of 40 miles per gallon. The impact of these modified hybrid vehicles would be significant because half the automobile miles traveled each day are within the first 20 miles of travel by each respective vehicle and about 78% of the miles are within the first 40 miles.

In fuel cell versions of PHEVs, the optimal size of the battery pack will depend on the application, but would typically be 7.5 to 15 miles. As summarized by the timeline at the right, the Electrical Power Research Institute 7 estimates PHEVs to start hitting the US market in 2005-Renault started marketing a PHEV in France in 2003. The “portable battery charger” approach is an innovation that makes PHEVs viable cheaper, faster, and better-the industry has already missed early market entry opportunities.

In this application, a 1.0 to 2.0 kW fuel cell would need to charge the battery pack (at work) in about 8 hours—the system's “required”[power]:[stored energy] ratio is low (−0.125 h⁻¹). The RFC cost-effectively replaces over half the battery pack.

The cost of a $4,000 battery pack is reduced to $2,900 for a RFC-battery pack combination.

Entry-level fuel cell PHEVs would be efficient, light-weight vehicles with 20 or more miles per day in plug-in range (sum of hydrogen and battery pack ranges). Plug-In vehicles would have lower gasoline consumption, but per-mile energy costs would be about the same as with the HEV. The fuel costs are about $0.025 and $0.032 per mile for gasoline ($1.00 per gallon, no highway tax) ICE and hydrogen produced with grid electricity (off-peak, $0.056 per kWhr). In countries where fuel prices are more than $4.00 per gallon as a mechanism to discourage importing of crude oil, it is possible for the PHEV to pay for itself based on savings in fuel costs if they are able to tap into cheap off-peak grid electricity. At fuel (and maintenance) costs of $0.082 per mile and electricity costs of $0.32 per mile, a $1,250 premium could be recovered in 25,000 miles. Actual electricity costs for electric vehicles using grid electricity are as low as $0.021 per mile.

Conversion kits to convert commercially available HEVs to fuel cell versions of PHEVs is a good approach to commercializing the technology.

For vehicles, the following illustrative example illustrates a novel heat management approach. A heat (and freeze resistant) management system suitable for use in the hybrid electric vehicles currently on the U.S. market will be designed for proposed Phase II fabrication. Calculations will be based on a approach of placing the stack in a well-insulated box on the vehicle. Even in extremely cold conditions, relatively continuous operation of the stack as either an electrolyzer or battery charger in a well-insulated box will prevent the freezing without additional expenditure of energy. When parked for multiple days, hydrogen an oxygen will be consumed to prevent freezing. As a final fallback position, the system will be allowed to freeze and batteries will be used to warm up the fuel cell prior to operation—this is practical since several miles of power are available in the battery pack.

The design calculations will be used to identify the amount of insulation and isolation that is necessary to provide satisfactory resistance to freezing. Calculations will identify the amount of time between vehicle operation that can transpire without additional energy being used to keep the stack warm. In addition, the calculations will determine the cost of keeping the system from freezing as an interim measure.

Within the design constraints identified for satisfactory cold-weather performance, and a stack cooling strategy will be identified. Calculations will be performed on the amount of cooling water circulation necessary to remove the waste heat from the stack during normal operation. A radiator will be located outside the insulated box to remove the heat form the water. The water circulation pump specifications will be identified as well as the radiator specifications.

Plug-In and Recharge Procedures: The preferred embodiments of this invention use the plug in to provide electrical power to the electrolyzer for producing hydrogen and oxygen. Both the hydrogen and oxygen are stored on the vehicle. The hydrogen and oxygen are produced from water that is preferably from the water tank. The preferred capacity of the electrolyzer is from 0.01 to 1.0 kg of hydrogen production per hour. The more preferred capacity is from 0.02 to 0.2 kg per hour.

A regenerative fuel cell system consisting of a pressurized regenerative fuel cell capable of producing hydrogen through hydrolysis of water and producing electrical power through electrochemical reactions of oxygen and a fuel, a pressurized electrolysis oxygen tank capable of storing between 0.2 and 100 kilograms of oxygen and having a oxygen tank volume consistent with storing the oxygen at a pressure between 50 and 500 bars of pressure, a pressurized hydrogen storage tank capable of storing between 0.025 and 12.5 kilograms of hydrogen and having a hydrogen tank volume consistent with storing the hydrogen at a pressure between 50 and 500 bars of pressure where the ratio of the volume of the hydrogen tank to the oxygen tank is between 1:1.6 and 1:2.1, a line with one end connecting the bottom of the hydrogen tank and a second end connected to the oxygen tank where the line is filled with a liquid that freely flows between the two tanks and equilibrates the pressures of the two tanks.

The liquid that flows between the tanks is preferably water. When using water, preferably a second line with one end connected to the oxygen tank and the second end connected to the entrance of a pump and a third line with one end connected to the exit of a pump and a second end connected to the cathode side of the fuel cell a monitoring and control means that pumps the water from the oxygen tank to the cathode side of the fuel cell to flood the cathode side of the fuel cell and allows electrolysis generation of oxygen and hydrogen by the fuel cell.

The hydrogen tank may be any tank known in the science for storing hydrogen including storage means that physically or chemically react with hydrogen to increase hydrogen storage density. The preferred hydrogen tank for this embodiment is a compressed gas tank capable of pressures up to 1,000 bar. The more preferred tank is capable of sustained hydrogen storage at up to 400 bar. The preferred volume of the compressed gas tank is between 0.5 and 200 gallons. The more preferred volume of the compressed gas tank is between 1 and 50 gallons with the most preferred volume of the compressed tank between 2 and 20 gallons.

The oxygen produced by the electrolyzer is stored in an oxidant tank including oxygen containment means known in the science including tanks. The preferred oxidant tank has a pressure rating similar to the hydrogen tank. The preferred volume of the oxidant tank is about one half the volume of the hydrogen tank.

In the preferred embodiment, the Plug in electricity is used to separate oxygen from air in addition to the aforementioned electrolysis. The preferred separation means is a gas separation membrane system using membranes that are more permeable to oxygen than to nitrogen. This membrane system uses a compressor to create the driving force for the membrane separation by methods known in the science. The compressor is preferably powered by an electric motor that can be powered directly or indirectly from grid electricity to separate oxygen form air when the fuel cell system is plugged in.

The energy used to separate oxygen from air and compress the oxygen may be from grid electricity or from excess power from the fuel cell. Preferably, grid electricity is used to store purified oxygen to the capacity of the oxidant tank.

In the most preferred embodiment, oxygen is stored in two separate oxidant tanks.

A first oxygen tank has a storage capacity of about one mole of oxygen for every two moles of hydrogen stored in the hydrogen tank. This first oxygen tank has a volume equal to about one half the volume of the hydrogen tank and is used to store electrolysis oxygen. The advantage of this volume for the oxygen tank is that the oxygen and hydrogen tanks will have similar pressures when filled form empty states through electrolysis and when consumed from states starting at the same pressures, and because they are at similar pressures the fuel cell can operate at the storage pressures without additional compression costs and without losses in available energy associated with expansion of the gases. When operating from the electrolysis hydrogen and oxygen, the preferred operating pressure of the fuel cell is the greater of either 1) the lower of the two pressures of the hydrogen and oxygen tanks or 2) the minimum pressure as identified by the controller.

A second oxygen tank stores oxidant from the air separator. The second oxygen tank preferably has a volume between about 1 and 100 gallons. More preferably, the second oxygen tank has a volume between about 4 and 20 gallons. This second oxygen tank allows the pressure of oxygen in the first oxygen tank to change with the pressure of the hydrogen in the hydrogen tank such that the first oxygen tank and the hydrogen tank are typically at about the same pressure.

Both the separation of oxygen form air and the compression of this separator oxygen gas are energy intensive. The separation and compression provides a very efficient means of energy storage and increases the power output potential of the fuel cell system. This separation and compression may be performed using grid electricity with the plug-in option or may be performed when the vehicle is in use as determined by the controller.

Recycle of Oxygen Between Fuel Cell and Membrane Air Separator: When operating from oxygen separated by air, the nitrogen content of the air is preferably less than 40%, and more preferably less than 10% by volume (or moles). Even at these low levels, the gases in contact with the cathode side of the membrane will become concentrated in water vapor. As the water vapor can condense and be drained by means of a water trap, the gas phase can also become concentrated in nitrogen. Increased nitrogen concentrations will cause the fuel cell power output to decrease. Preferably, the cathode side purge is used to remove nitrogen from the fuel cell system as a cathode purge stream.

In the preferred embodiment, the cathode purge stream is recycled back to the air separator. The cathode purge stream preferably has an oxygen concentration between 60% and 98% and is at a pressure of the fuel cell less the pressure losses associated with friction flow of a compressible fluid. This recycled cathode purge stream is introduced into the air separator by methods know in second law thermodynamic analysis so as to minimize the loss of available energy that occurs when the recycled cathode purge stream is mixed with a stream in the air separator.

By example, for an air separator that consists of the following three stages:
Stage 1: air entering at about 21% oxygen is separated to an 01 stream containing about 60% oxygen and R1 raffinate stream containing about 19% oxygen. The 01 stream is at less than atmospheric pressure
Stage 2: 01 stream is compressed to about 3 bars of pressure and enters stage 2. Exiting stage two is an 02 stream containing about 90% oxygen and a R2 stream containing about 21% oxygen.
Stage 3: The 02 stream is compressed to about 10 bars of pressure and enters stage 3. Exiting stage three is an 03 stream containing about 98% oxygen and an R3 stream containing about 60% oxygen.

By this example, the recycled cathode purge stream is mixed with the 02 stream between stages 2 and 3 based on similarity of oxygen concentrations and because this stream has the highest pressure of the intermediate streams in the air separator.

Series Fuel Cell Stack Arrangements: In the most preferred embodiment, the fuel cell stack is comprised of groups of fuel cells. At least two groups of fuel cells are connected in series such that the oxygen from the separator and tanks flow into a first fuel cell group wherein the cathode purge stream from the first fuel cell group is connected to the cathode entrance of the second fuel cell group. Functionally, the fuel cell groups are connected so the first fuel cell group receives oxygen of the highest purity available from the separator or tanks while the second fuel cell group receives oxygen that has been depleted in oxygen and has higher concentrations of inert gases such as nitrogen relative to the oxygen concentration. This arrangement of fuel cell groups is a series arrangement. Much as series heat exchange increases the overall efficiency of a heat exchanger, this series arrangement of the groups of fuel cells in a fuel cell stack increases the overall efficiency of the fuel cell stack.

Optionally, the second group of fuel cells may have different design parameters to better utilize the hydrogen and oxygen available from the fuel and oxidant gases. Specifically, higher catalyst loadings will partially compensate for reduced concentrations of oxygen and hydrogen in the oxidant and fuel gas streams.

The operation of these fuel cells in series is less important for the oxygen and hydrogen generated by electrolysis than for the oxygen and hydrogen generated from air separation and reforming, respectively.

In the most preferred case when using oxygen from air separation, the oxygen concentration (water-free basis) in the first fuel cell group goes from about 98% to about 80%. In the second group the oxygen concentration (water-free basis) goes from about 80% to about 40%. The membrane surface area of the first fuel cell group is about twice the membrane surface area of the second fuel cell group.

In the most preferred case when using hydrogen from reforming, the hydrogen concentration (water-free basis) in the first fuel cell group exits at about 20% hydrogen. In the second group the hydrogen concentration (water-free basis) exits at less than about 5%.

Alternative Embodiments: An alternative embodiment of this invention does not have a air separator. Oxygen is created by electrolysis. In this embodiment, the stored hydrogen may be used with air or stored oxygen or a combination of air an stored oxygen. When the stored hydrogen is used with air in the fuel cell, more oxygen is stored than is needed for the hydrogen of electrolysis. Increased power is provided by increasing the ratio oxygen provided to the fuel cell relative to the amount of air provided by the fuel cell. This method of increasing power output allows the output of the fuel cell to be increased beyond that which is possible if the fuel cell could only operate with air.

Optionally, in a refueling process liquid fuels are filled into the liquid fuel tank, a plug-in option will allow hydrogen and oxygen to be generated and stored during the refueling process. Optionally, compressed oxygen or compressed hydrogen may be filled into the oxygen tank or hydrogen tank during the refueling process.

Optionally, an auxiliary fuel cell stack system may be rented for long trips to increase efficiency and therefore provide the extra power. The embodiments of this invention provide a location for attaching an auxiliary fuel cell stack. The embodiments of this invention provide an auxiliary oxidant line, fuel line, cathode purge line, anode purge line, and electrical interfacing for attaching the auxiliary fuel cell stack.

These embodiments are not limited to application with PEM fuel cells. The high pressure and oxygen enhancement options generally work with other fuel cells including methanol fuel cells. Preferably, a methanol fuel cell capable of operation with either hydrogen or methanol as a fuel would be operated with electrolysis hydrogen and liquid fuel methanol. Alternatively, the fuel cell is capable of directly using both a liquid fuel and hydrogen to produce electricity. Here, directly using refers to the process where the fuel is supplied to the anode side of the fuel cell, preferably as a vapor, and the fuel cell is able to use the fuel to produce electrical power. The methanol fuel cell is an example of a fuel cell capable of directly using methanol to produce electricity.

More On PEV-FCBC Alternative Embodiment—A power supply for a plug-in hybrid electric vehicle consisting of a battery pack capable of providing a power output between 20 and 1000 kW, a fuel cell capable of providing a power output between 0.2 and 20 kW, a hydrogen fuel tank with a rated capacity rated in miles of travel at an average city fuel economy rating where the rated capacity in miles is equal to between 4.5 and 18 times the fuel cell maximum power rating in kW, and a control means that utilizes the power output of the battery pack to provide the high power needs of the vehicle and uses the fuel cell as a battery charger to charge the battery pack. The preferred PEV-FCBC system includes the following:

| | Preferred | More Preferred | Most Preferred |
|---|---|---|---|
| Fuel Cell Battery | 0.5-20 | 1-10 | 1.5-5 |
| Charger Power | | | |
| Output (kW) | | | |
| Capacity of Stored | 5-300 | 10-100 | 20-60 |
| Hydrogen/Oxygen | | | |
| (miles) | | | |
| Battery Pack | 20-1000 | 20-200 | 40-100 |
| Power Output (kW) | | | |
| Battery Pack Capacity | 1-50 | 2-30 | 4-20 |
| (miles) | | | |
| Backup ICI Engine | 20-1000 | 20-200 | 40-100 |
| Power Output (kW) | | | |
| Fuel Storage for | 20-500 | 40-300 | 100-250 |
| Backup ICI Engine | | | |
| (miles) | | | |

Alternatively, the fuel cell battery charger power output may be as low as 0.2 kW and the more preferred range is 0.5-10 kW.

The preferred mode of operation includes charging the battery and electrolyzing water to produce hydrogen and oxygen while the vehicle is plugged into the electrical power grid. This is preferably done at night such that battery, hydrogen tank, and oxygen tank are full (fully charged) for travel each morning. This charging is preferably performed with a battery charger powered by grid electricity and an electrolyzer powered by grid electricity. The electrolyzer may be a regenerative fuel cell—the same fuel cell as referred to as the fuel cell battery charger.

As indicated by the above table, the fully charged capacity is most preferably from 24 to 80 miles. The vehicle control system uses this charged capacity to power the vehicle without running the backup ICI engine when possible. High power demands are supplied primarily by the battery pack with a small amount of assistance from the fuel cell battery charger. When the vehicle demands less energy than available from the fuel cell battery charger and when the battery pack is not fully charged, the power from the fuel cell batter charger (not being used by the vehicle) is used to charge the battery pack. This preferably occurs at all times when the battery is not fully charged even when the vehicle is parked provided hydrogen and oxygen are available. At times when the battery pack capacity is depleted and the combination of the battery pack and the fuel cell battery charger cannot provide the vehicle with enough power, the backup ICI engine operates to provide the additional power. For Many applications the backup ICI engine may go for weeks at a time without running. In an alternative embodiment, the vehicle is used without a backup ICI engine.

The following table shows the various states of being charged for the battery, hydrogen, and oxygen tanks during an example 24-hour day:

| Hour | Miles | H2 | Battery |
|---|---|---|---|
| 0 | 0 | 16 | 10 |
| 7 | 0 | 30 | 10 |
| 7.25 | 6 | 29.25 | 4.75 |
| 12 | 6 | 24 | 10 |
| 13 | 11 | 21 | 8 |
| 17 | 11 | 19 | 10 |
| 17.25 | 17 | 18.25 | 4.75 |
| 19 | 17 | 13 | 10 |
| 21 | 27 | 7 | 6 |
| 24 | 27 | 16 | 10 |

Alternative applications are with motorcycles. The preferred motorcycle applications do not include air separation membranes. Rather plug-in fuel cells are preferably designed to run off oxygen of >90% purity and hydrogen—preferably generated from electrolysis. Fuel cell systems where oxygen and hydrogen storage on the vehicle is such that about 1 mole of diatomic oxygen is stored for every 2 moles of diatomic hydrogen and where the volume of the hydrogen storage tank is about twice the volume of the oxygen storage tank so as to maintain about equal pressures in the two tanks during use.

Fuel cell system for motorcycles have, optional to plug-in recharging of hydrogen and oxygen, refueling by replacing oxygen and hydrogen tanks on the vehicle that are relatively low in loadings of oxygen and hydrogen with tanks that are relatively high in loading of oxygen and hydrogen.

Fuel cell system for motorcycles have, replaceable tanks on a motorcycle where the oxygen tank and hydrogen tank and connected as one assembly with at least one port for oxygen discharge from the oxygen tank and at least one port for hydrogen discharge from the hydrogen tank where these ports have connections that connect in the downward direction. The said tank assembly has a handle and automatic connection means such that lifting of the tank causes disconnection of the two connectors from the motorcycle and pushing down on the assembly causes connection of the tank to the motorcycle where said tank assembly has a handle on top for ease of handling the tanks.

More on Siphon Reboiler and Combined Collector-Photovolatic Solar Panel System—In a photovoltaic solar panel system, hot water and space heat are also produced by placing the regenerative fuel cell stack into a siphon reboiler configuration where density differences feed water to the reboiler from a hot water heater and the hot water is returned to the hot water heater.

Heat production is increased by placement of water flow tubes in the solar panel where water flows through the panel to preheat water prior to heating to final temperature.

An Illustrative Example of This System Is As Follows: A high-pressure RFC would be operated at temperatures in excess of 80° C. and could be operated at temperatures in excess of 80° C. At these temperatures, the waste heat (approximately 64% of the energy going to the stack from the RFC stack, 64%=100%−[60%]2). This heat is of sufficient quality for heating water, space heating, and/or some air conditioning cycles. Furthermore, this high quality heat could be augmented by lower quality heat from the solar collectors on the roof.

Water will pass through the cooling channels in the stack much like water passes through a siphon reboiler. Calculations will be performed on the viability of this approach and heat transfer constraints will be specified. Water from a low location in a water heater will enter at the bottom of channels in that are incorporated into bipolar plate heat exchange elements of a stack. As water is heated and even boils, the lower densities will cause flow to the hot water heater where flow initiating at the top of the stack enters the hot water heater.

More on Window and/or Mirror Configuration in Solar Panel System—In a solar panel, surfaces of photovoltaic cells are in a plane at an angle arrived at from a reference perpendicular to a horizontal line going north-south and with said photovoltaic panel pain being about 30 degrees off vertical from said reference plane said angle corresponding to receive about maximum sunlight in the winter. The panel embodiment includes alternating section of the panel plane and reflective planes that are about 90 degrees off vertical where winter sun also reflects off the said reflective plane onto the photovoltaic plane.

The panel embodiments includes alternating section of the panel plane about 8 feet in length along the horizontal and about 0.5 feet in width along the 30 degree angle from vertical. Said horizontal reflective planes of about same length and width are aligned edge-to-edge with the photovoltaic planes. Typical panels consist of about 8 of each photovoltaic and reflective planes. The width of the reflective planes is preferably varied to give an overall slope of the panel embodiment that matches the slope of the roof. The advantage of this configuration is that is both covers the roof surface and increases the amount of light that reaches the photovoltaic cells.

Bipolar Plates Covered with Plastic Except for about 2% of Area Use for Conduction—Bipolar plate configurations are described in an example configuration. By example, coated aluminum sheets will be pressed into geometries that will provide gas/water distribution. Coated metal sheets have historically been successful in this application. A screening method will be used to coat about 98% of the plates with a Teflon (or Parylene, or other protective material) coating that will provide high resistance to corrosion—this coating should be non-conductive and should reduce corrosion problems by a factor of about 50 as compared to uncoated metal. The 2% that is not coated will be located on ridges that have good contact with the catalyst and carbon cloth of the MEA.

Initially, these will be used without further processing. If problems manifest, the partially coated plates will be electroplated with a corrosion resistant material such as gold (patent pending on this approach). Pressed brass or copper sheets will be used in place of pressed aluminum as necessary.

On the perimeter of each bipolar plate (about 20 mils), a 0.5 inch wide perimeter (about 40 mils) will be pressed and epoxy glued into place. This perimeter allows for the flow channels to be pressed into the internal sections. Multiple coatings of Teflon (or other non-conducting polymer) will be placed on the perimeter to electrically insulate the separate bipolar plates from one another.

Molds to create the ridges can be custom-manufactured from aluminum stock. After the perimeter is placed on the sheets, holes will be drilled into the perimeter to match up with the bolt locations that hold the stack together. In addition, access holes will be drilled that provide flow of gases to and from the fuel cell. The flow patterns will then be pressed into the middle section of the plate. Next, a Teflon coating will be applied using a screen to prevent coating on about 2% of the sheet that will be relied upon to conduct current between the bipolar plate and MEA. Optional electroplating would then be performed. These plates are then ready for assembly into the stack as described in Task 2.

As necessary, bipolar plates will be fabricated machined from 0.375 aluminum stock to provide for heat transfer.

Approximately every 6th plate will be fabricated in this way with 3/32nd inch 10 channels drilled at ½ inch spacing to provide for heat transfer. These plates will be Teflon coated in a similar way as the other bipolar plates.

A fuel cell using metal bipolar plate where 80% to 99.8% of the surface of the metal bipolar plate is covered by a non-conducting coating that protects the metal from corrosion and at least part of the uncoated metal of the bipolar plate is in contact with a membrane electrode assembly of the fuel cell and has electronic connectivity with the membrane electrode assembly.

More preferably, the coated bipolar plate has 95-99.5% of the surface of the surface of the metal bipolar plate is covered by a non-conducting coating.

More preferably, the coated bipolar plate a polymer coating, the metal is a pressed metal with raised surfaces that create spaces for gas flow, and the uncoated surface metal of the bipolar plate is primarily on those areas of the pressed metal in contact with the membrane electrode assembly.

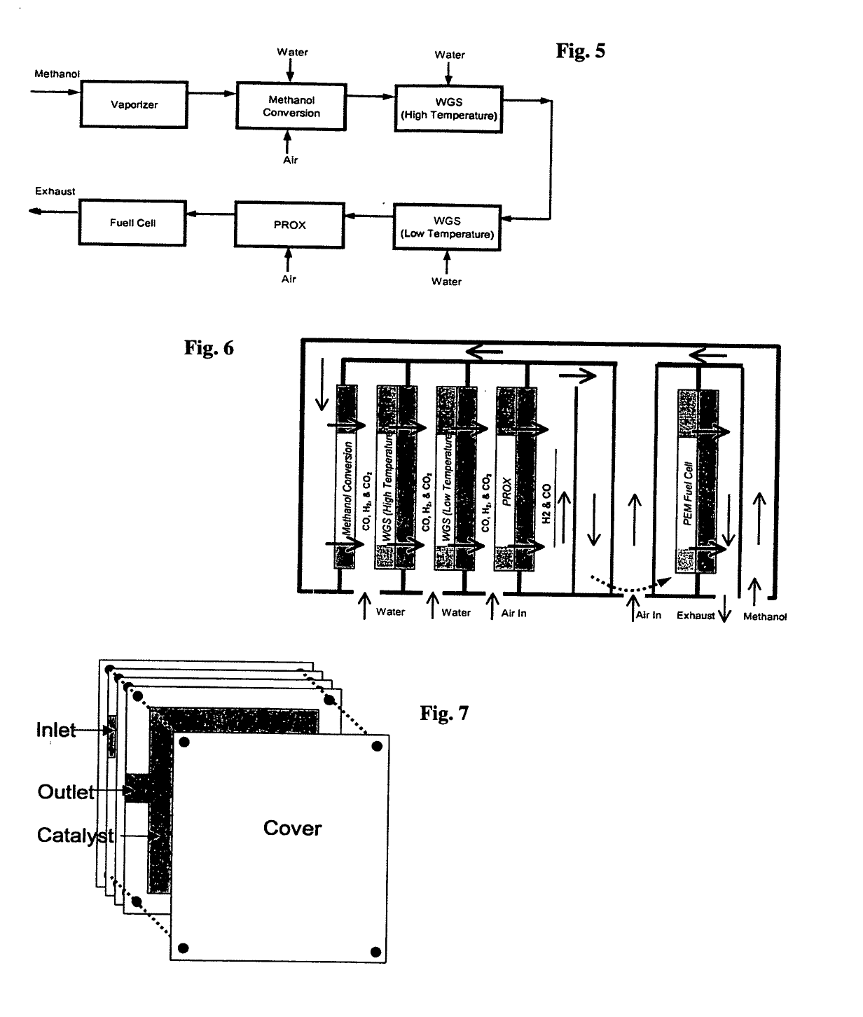

Thin-Gap Module Approach to Fuel Cell Integration: The preferred method to integrate a reformer with the regenerative fuel cell is to use thin-gap module architecture. FIGS. 5, 6, and 7 illustrate the narrow-gap module approach and compare the narrow-gap module approach to conventional designs with an example illustrating methanol reforming followed by hydrogen utilization in a PEM fuel cell.

The block-flow-diagram of FIG. 5 is indicative of current construction methods where the blocks represent vessels and the lines represent tanks. The side-view of the narrow-gap module approach shown by FIG. 6 illustrates flow patterns of methanol, air, water, intermediates, and exhaust. Here, a series of parallel plates indicated by shaded rectangles are separated by narrow gaps. Finally, FIG. 7 illustrates how the plates are assembled. Multiple modules may be used to meet increasing system capacity.

The narrow-gap modules will (1) substantially reduce the cost of producing chemical production facilities, (2) leapfrog our current capabilities for automating the process of taking an chemical process idea from concept to commercialization, (3) allow advanced chemical, membrane, and electro-chemical processes to be better incorporated into chemical processes, (4) reduce the time and cost to take a process from concept to commercialization, and (5) capitalize on the multitude of advantages associated with modular and mobile chemical process architectures.

Relation of System Architecture to Ability to Automate Construction—The path from concept to process and eventual product commercialization in the chemical industry is one of the most arduous commercialization paths in modem society. Common steps from concept-to-process include (1) concept development, (2) laboratory demonstration, (3) laboratory optimization, (4) process development and optimization, (5) one or more process scale-ups, and (5) commercial process construction. Automation of current construction methods would be virtually impossible due to the craftsmanship involved in pipefitting, electronics (including data acquisition), and industrial construction.

The greatest breakthroughs that could happen in the chemical industry are the recognition and conquering of paradigms that limit architecture and thereby indirectly hinder our ability to take concepts to commercial processes. Due to the craftsmanship nature of pipefitting, industrial data acquisition/control electronics, and industrial construction, only those approaches that largely eliminate these components of chemical process construction will reach the ultimate goal of allowing automation of the concept-to-process procedure.

The narrow-gap module approach largely eliminates pipefitting, traditional electronic infrastructure, and the construction techniques involved in chemical process fabrication. This is accomplished by replacing vessels and pipes with plates, gaskets, and spaces that can be systematically aligned into modules. For commercial scale production, banks of modules are connected in a manner providing large but mobile structures designed to provide desired heat transfer (or lack of heat transfer), connectivity, and structural integrity.

Reducing Cost of Process Plant Construction—In the process of replacing vessels and pipes with pseudo two-dimensional plates and gaskets, the construction process is transformed to molding, pressing/stamping, and printing processes-the construction process costing 5 to 6 times the raw materials costs is transformed to a manufacturing process costing about 2 times the raw materials costs. New chemical processes can be developed at a fraction of the costs and time of traditional processes.

By transforming chemical plant construction to a manufacturing process susceptible to automation, the narrow-gap module approach creates new economies-of-scale having high efficiencies, reduced construction times, and decreased costs through mass production of modules that can be combined to virtually any desired scale of liquid or gas processing. This is accomplished by mass production of modules, each containing all the elements of a production process or subsection of a production process.

Micro-to-Macro Scales in the Chemical Industry—Lerou and Ng (1996) and Alkire and Verhoff (1994) discuss the relation of length and time in a multiscale approach. Three important scales of length-time space are (1) molecular/electron scale, (2) fluid dynamics and transport scale, and (3) production scale. Narrow-gap technology (plates being 10 μm to 10 mm thick in the direction of flow) is designed within the fluid dynamics and transport scale to substantially reduce transport limitations encountered in chemical production.

To a first approximation, the modular approach creates production scale lengths by grouping modules together. Fundamentally, residence times and residence time distributions determine performance while large travel paths are more an artifact of linear construction methods than they are a necessity for proper performance. In reactors, plug flow behavior is typically preferred and is achieved by using axial to radial dimension ratios <0.1. This presents a paradox for the narrow-gap module approach where axial (plate/gasket thickness) to radial (width/height of the plate) dimension ratios would typically be >10.

Achieving narrow residence time distributions and residence times >1-5 minutes thus is one of the first challenges of the narrow-gap module approach. Recognizing that such performance is common in reservoir engineering, the solution to this challenge resides in the use of porous media to create an environment where near-plug-flow patterns can be established at slow flow rates. In a similar manner, porous media can be used in module plates to establish high residence times in thin plates as needed.

Although narrow-gap technology is designed at the transport scale, it is inherently compatible with conventional approaches of molecular/electron scale processes. Convection flows/paths can be created to provide an optimal balance of transport and convection for electron scale processes (Nguyen and Yi, 1999; Nguyen and Vanderborgh, 1998, Nguyen, 1996). The plate approach is used for fuel cells and has been identified as one of the better methods to direct electron scale phenomena into useful results.

In principle, the narrow-gap approach is one of adapting traditionally production-scale processes to the transport scale so as to (1) allow fabrication by lower cost methods, (2) overcome transport limitations of production scales, and (3) better facilitate integration with electronic scale phenomena.

Additional Details on Design of Narrow-Gap Modules—The narrow-gap module approach uses unit operations incorporated in plates and neighboring gaps. The plates are partially comprised of membranes, porous media, or thin walls and allow the transport of heat or mass per their design. Pipes are replaced with porous or membrane media, reactors are replaced with catalytic/porous wafers incorporated in plates, heat exchange is achieved by placing flow paths in close proximity, and vapor-liquid separation can be achieved in gaps/modified-gaps between plates. Economies-of-scale are realized by mass-producing modules-each of which is an independent chemical production facility.

Each module is comprised of a series of parallel plates. Although dimensions may vary, typical research sizes would be about 10 cm×10 cm×<0.5 cm for the module plates with the modules comprised of several plates and gaps totaling about 2 cm in thickness. The side-view (FIG. 6) shows flow patterns through the plates where the chemicals are influenced by the plate functionality that could range from selective ion transport to reactive/porous surfaces.

Pressure gradients force flow through the plates and gaps of the module. Each plate is designed to promote uniform flow throughout by (1) the porosity of the solid catalyst or plate support, (2) the transport of ions or molecules through a membrane embodiment, or (3) any combination of methods used to control flow through solid matrices. Each plate (and respective gap) is independently developed and manufactured to provide a particular function or series of functions. The plates are combined by methods providing flow patterns allowing the introduction or removal of gases or liquids.

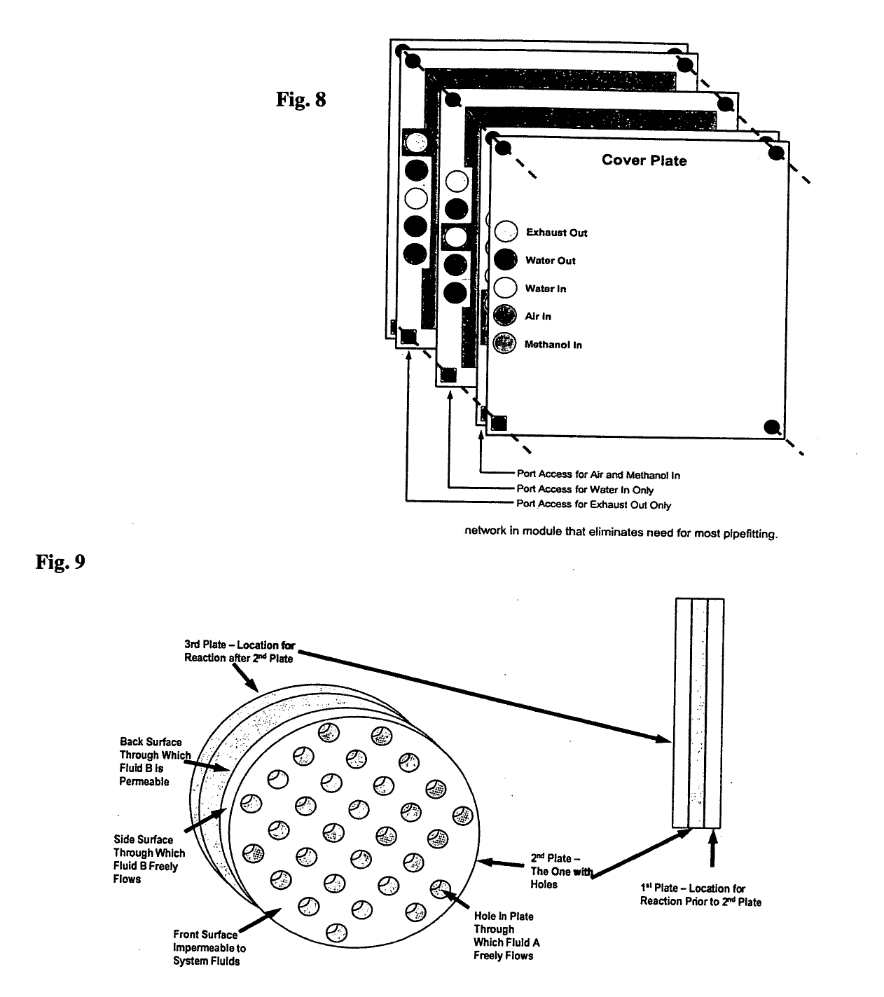

Networking of Narrow-Gap Modules—FIG. 7 illustrates how fluids are introduced and removed from plates and gaps by slots going from the module exterior to the active area/volume of the plate/gap. Although the access slot approach would work, it would also create a piping nightmare. For conventional processes, the design, purchase, and fitting of pipes can represent >30% of the final production facility cost, and so, the cost of chemical process plant construction is substantially dependent upon the cost of the networking created by pipes. FIG. 8 presents a solution to this networking problem that not only meets networking needs but is susceptible to automated low cost manufacturing.

FIG. 8 illustrates one module for methanol conversion and use in a fuel cell. Multiple modules could be connected together to form a bank of modules served by a single cover plate similar to the cover plate illustrated by FIG. 8. Multiple banks could be stacked and placed adjacent to each other for compact, convenient, and mobile designs.

Influents are introduced at the cover plate and products are removed. Fluid access to the functional areas of plates is determined by plate architecture at that particular port. FIG. 8 illustrates access by three plates, one plate allowed influents to flow into the active area of the plate, one plate allows water to access the plate's active area, and one plate allows products to be discharged from the active area. In advanced designs, orifices would meter flows to the plates based on principals of statistical process control (SPC).

One of the potential problems of performing multiple sequential reactions in a module comprised of multiple parallel plates is the mixing of chemicals between plates. FIG. 9 illustrates a preferred method for mixing chemicals consisting of Fluid A (a liquid or gas) proceeding from a first reaction plate that mixes with Fluid B prior to reaction. In this embodiment, fluid B is introduced into a porous plate (2nd plate) where the side of the plate facing the first reaction plate is sealed to prevent flow of Fluid B in that direction while the side of the plate facing a third plate (reaction plate) is permeable such that the resistance of flow at that plate surface is greater than the resistance of flow generally through the porous internal section. This high resistance to flow at the surface will generally cause Fluid B to have the same flux/flow along the entire surface.

Preferably, a gap after the 2nd plate allows mixing of Fluid A and B. Fluid B is largely evenly distributed due to the membrane-like surface. Fluid A is preferably distributed on a macro scale such as through the use of impermeable holes in the second plate or through a maniflolding system in a plate format situated between the second and third plates. The system of FIG. 9 works particularly well when the flow rate of Fluid A is at least 5× greater than the flow rate of Fluid B such as for the preferential oxidation of CO in a CO—H2 mixture through the introduction of oxygen.

The thin-gap method of chemical process design and manufacturing overcomes current paradigms in the industry, thereby allowing revolutionary advances comparable to those in the electronics industry when vacuum tubes were displaced with integrated circuits. The thin-gap module approach to chemical process design creates new economies-of-scale having high efficiencies, reduced construction times, and decreased costs through mass production of modules that can be combined to virtually any desired scale of liquid or gas, processing. This is accomplished by mass production of modules, each containing all the elements of a production process or subsection of a production process.

The primary goal of the thin-gap module approach is to convert the construction of a chemical process plant from one of fabrication and construction to one of molding, pressing, and/or printing. When this is accomplished without a substantial increase in materials' costs, the costs of constructing new chemical facilities are substantially reduced.

Implicit in this approach is that the manufacturing method is justified based on the number of units being produced. For a chemical process this translates to mass production of relatively small modules that can cumulatively meet production goals. For some production facilities such as fuel cells for automobiles, the small module approach is about the only reasonable option. For processes such as gas-to-liquids technology, the suitability of the module approach is less obvious, yet none-the-less, the approach is appropriate and preferred. The approach has applications to a wide range of chemical production processes.

An additional goal of the thin-gap module approach is to eliminate the need for pilot-scale and semi-commercial phases of process development. Since laboratory methods are performed on the same scales as the modules making up large production facilities, demonstrations at the laboratory level are equivalent to demonstrations at the commercial scale. The time it takes to go from laboratory demonstration to commercial production is reduced from years to weeks.

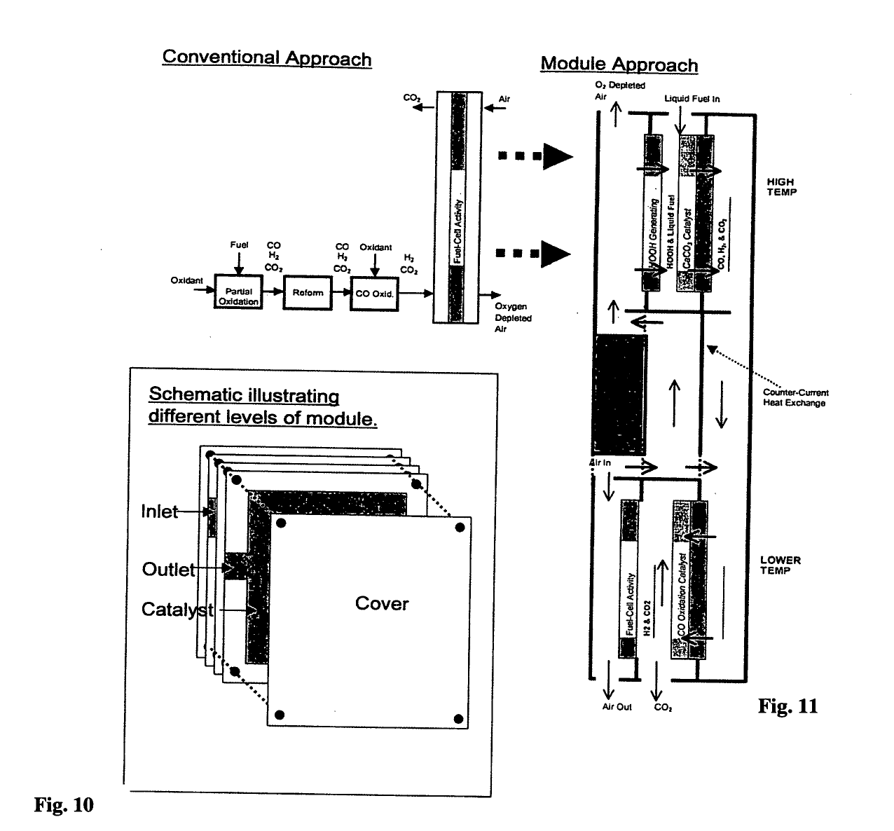

FIGS. 10 and 11 illustrate the thin-gap module approach. FIG. 10 illustrates how two covers and three functional plates can be bolted together to form a module. FIG. 11 compares the conventional approach of separate vessels to the thin-gap module approach. FIG. 11 provides a cross-sectional view showing preferred flow patterns of (1) flow through plates with catalysts promoting a desired reaction and (2) flow next to plates through which heat is transferred.

The thin-gap module approach uses unit operations incorporated in plates alone or the combination of plates and neighboring gaps. The plates are partially comprised of membranes, porous media, or thin walls and allow the transport of heat or mass per their design. Pipes are replaced with porous or membrane media, reactors are replaced with catalytic/porous wafers incorporated in plates, heat exchange is achieved by placing flow paths in close proximity, and vapor-liquid separation can be achieved in gaps/modified-gaps between plates. Economies-of-scale are realized by mass-producing modules-each of which is an independent chemical production facility. Optimal sizes of modules depend upon the process in a manufacturing run.

Each module is comprised of a series of parallel plates. Although dimensions may vary, typical research sizes would be about 5 cm×5 cm×<0.5 cm for the module plates with the module sectionss comprised of several plates and gaps totaling about 1 cm in thickness. In practice, a large number of module sections are connected face-to-face to make box-shaped modules. The side-view shows flow patterns through the plates where the chemicals are influenced by the plate functionality that could range from selective ion transport to reactive/porous surfaces.

Pressure gradients force flow through the plates and gaps of the module. Each plate is designed to promote uniform flow throughout by (1) the porosity of the solid catalyst or plate support, (2) the transport of ions or molecules through a membrane embodiment, or (3) any combination of methods used to control flow through solid matrices. Each plate (and respective gap) is independently developed and manufactured to provide a particular function or series of functions. The plates are combined by methods providing flow patterns allowing the introduction or removal of gases or liquids.

Assembly of the module could be performed by a variety of methods including gluing, bolting, welding, brazing, or soldering the plates/gaskets/spacers together near the plate perimeters and other methods known in the art. The primary elements of the modules include plates, gaskets, spacers, cover plates, and elements designed to allow access for electronics or chemicals. Reactants and products flow through openings in the covers or slots/voids in the plates, gaskets, and spacers. Plates are designed to be manufactured by pressing, molding, and in some instances printing, and so, they are susceptible to mass production at lower costs than current construction methods of the chemical process industry.

To a first approximation, the modular approach creates large lengths by grouping modules together, and so, production scale is achieved. To a second approximation, traditional relations between reactor length and residence time (especially the ratio of axial diffusivity and axial convection in a flow reactor) present a paradox for thin-gap technology; however, large residence times with minimal back mixing over small distances are achievable. Such performance is common in reservoir engineering. Reservoir dynamics present a time-tested example of how porous media can create an environment where near-plug-flow patterns can be established at very slow flow rates. In a similar manner, porous media can be used in module plates to establish high residence times in thin plates as needed.

Although thin-gap technology is designed at the transport scale, it is inherently compatible with conventional approaches of molecular/electron scale processes. Convection flows/paths can be created to provide an optimal balance of transport and convection for electron scale processes (Nguyen and Vi, 1999, Nguyen and Vanderborgh, 1998, Nguyen, 1996). The plate approach is used for fuel cells and has been identified as one of the better methods to direct electron scale phenomena into useful results.

In principle, the thin-gap approach is one of adapting traditionally production scale processes to the transport scale so as to (1) allow fabrication by lower cost methods, (2) overcome transport limitations of production scales, and (3) facilitate integration with electronic scale or membrane processes.

Typical unit operations of the chemical industry for liquid and gas processing include heat transfer, single stage vapor- liquid separation, multiple-stage vapor-liquid separation, single stage liquid-liquid separation, gas-liquid contacting processes, multi-stage liquid separation, and flow reactors. Typical designs of these unit operations are pressure vessels. These vessels are typically cylindrical in nature and connected with pipes. The present invention is based on the use of plates rather than vessels and flow between plate/gap-based unit operation in thin gaps, porous media, or membranes rather than in pipes. The plates are combined in modules. Flow paths from module entrance to module exit are created to allow a series of unit operations to be performed on liquids and gases flowing through the module.

A design philosophy is used to design the plates. This philosophy is as follows:

Plates, and in some instances plates and respective gaps, are designed to provide residence times and contact with surfaces in such a manner that the plates achieve unit operation tasks and such that the plates can be mass produced (manufactured) by stamping/pressing, injection molding, or printing methods.

This invention includes the design of these plates and methods of fabricating plates and modules.

This invention includes a method of combining plates designed with this philosophy such that the plates are mostly parallel to each other (see FIGS. 9 and 10) and are joined with sealing surfaces to provide internal flow paths that are isolated from external environments except as designed for fluid entrance or exit. Each module contains at least one plate designed for the flow of non-charged compounds in the general direction perpendicular to the plate surface—unlike electrochemical membranes where the membrane is designed to promote flow of charged compounds, the said one-plate is designed to promote the flow of uncharged compounds.

The design of the plates, location of the plates, and fluid properties and flow rates determine the efficiency of the plate toward achieving a unit operation. Details of plate design are specific to the unit operation.

Having described the general invention, specifics of plate and gap designs and uses are now described.

Parallel Thermal Management—For a thin-gap module, extremely efficient heat exchange is achieved between the thin compartments separated by the membranes/sieves/plates. The efficiency of this heat transfer can far exceed that which is possible with a heat transfer fluid conveying heat between two unit operations. The best advantage is realized when endothermic process plates are located next to exothermic process plates. For example, endothermic reforming can be located next to exothermic Fischer-Tropsch polymerization. Merely locating gaps next to each other with parallel faces facilities this heat transfer. Often times the flow rates through modules are rather slow, therefore, conductive heat transfer effects can effectively progress against convective mass transfer. For example purposes, FIG. 2 illustrates how endothermic reforming can be placed prior to and next to Fischer Trospch polymerization.

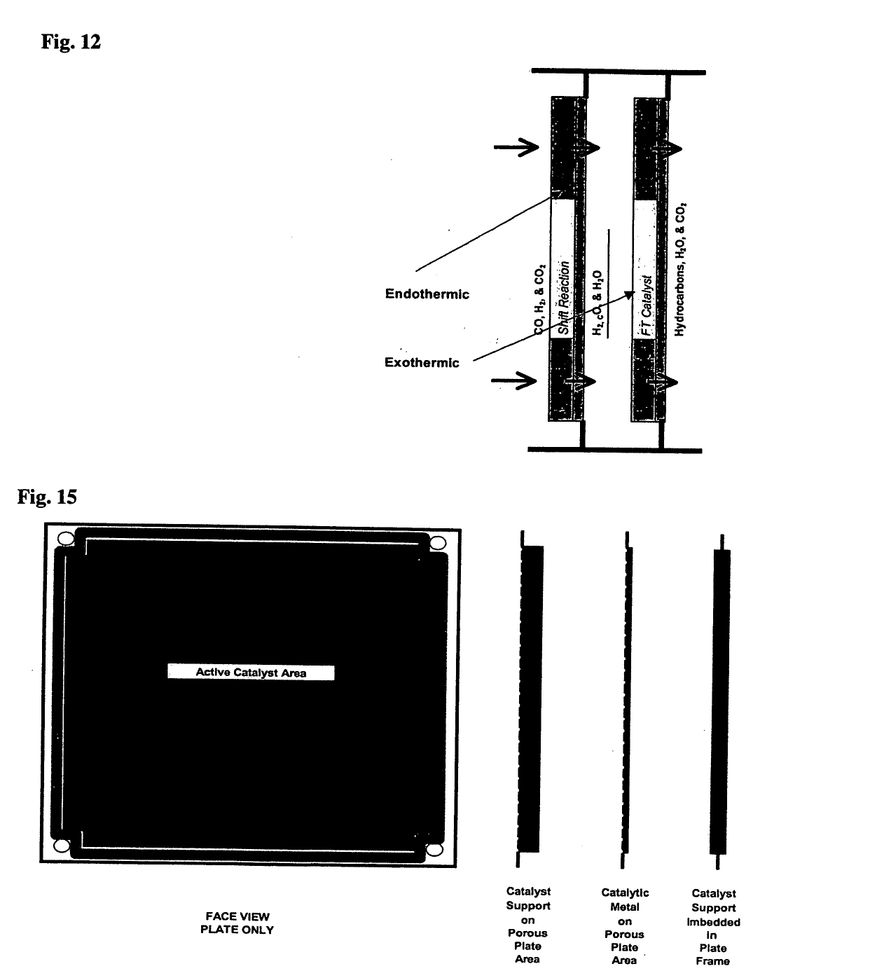

Different processes can be located in the same module for heat transfer advantages. This type of heat transfer is inherent in the design of the thin-gap modules, whereas for conventional unit operations similar heat transfer can be quite costly. For example purposes, FIG. 12 shows one configuration for achieving heat transfer between reactions that are not sequential within the same process. An additional heat transfer plate separates the product of reaction 1 from the reactants of reaction 2. The influent streams may be from a different location in the module or from a location outside the module and are not necessarily from the same process.

Counter-current Thermal Management—FIG. 11 illustrates how thin influent and effluent gaps provide natural surfaces for heat transfer with a heat transfer plate separating the streams. This procedure is important for recovering heat from a product exiting a process operating at a temperature significantly higher than ambient temperature as well as for allowing different sections of the module to operate at different temperatures. The high surface-area-to-volume flow paths are ideal for heat transfer that is far more efficient than would be possible in traditional processes. In addition, fouling of heat transfer surfaces can be minimized since the chemicals of the process are largely isolated from metals or contaminants such as lubricating oils.

Heat Transfer to Surroundings-Elimination of Cooling Water Towers—For applications where air cooling is sufficient, thin-gap modules provide an improved opportunity for heat transfer directly from the module to surrounding air. This is accomplished by extending the thin plates of the module in any, some, or all of the directions outside the sealing perimeter. Such a module would have one or more sides having appearances similar to the cooling fins on an air-cooled engine. Fans can be used to direct air through the cooling fins of large groupings of modules. When cooling fins are used, they will provide valuable parameters in determining the optimal size (length and/or width) for the modules.

FIG. 13 illustrates a plate that has one side extended to provide a cooling fin. The side view of the module section illustrates the air paths. The module section illustrates a reactant entrance (upper left) and product exit (lower right) and comprises a series of unit operations. The functionality of the locations on the plate are indicated; however, no inference is made on the type of materials or continuous nature of materials from one functional location to the next. Gaskets between plates are an option alternative to building up the sealing perimeter surface.

These module sections are connected in series as illustrated by FIG. 14 to provide an entire module. The face-to- face arrangement of the module sections can be arranged to reduce thermal insulation requirements on the section faces. Those skilled in the science are able to design and locate the cooling fins to achieve performance goals. The ordered nature of entrance and exit locations as well as having the entrances staggered from the exits allow for convenient manifolding arrangements for introducing reactants and removing products.

Thermal Insulation—If insulation is preferred to heat transfer, module perimeters can be insulated. Preferred to insulating modules is to place modules face-to-face in long rows where faces are designed to have similar temperature profiles (see FIG. 14). Similarly, modules can be located side-to-side in arrangements with similar temperature profiles to further reduce thermal insulation requirements. Thermal insulation may be placed on any face or side of a plate as needed.

This face-to-face arrangement can provide incorporation of a cascading phenomena to facilitate the heating process of system startup. For example, if several of the modules of FIG. 11 were arranged face-to-face, the partial oxidation section of the first module could be heated during startup with an electrical heating device. After the first section is operating, its exothermic reaction would be used to assist with warm-up/startup of the next module section, then the next section and so on in a cascading effect.

Residence Time and Disengaging Sections—Somewhat implicit in the discussion to this point is that traditional unit operations and/or vessels are typically replaced with one plate or one plate and one gap in a module. A unit operation can be created by a plate alone or by the combination of a plate and gasket/gap. In some instances a second plate is necessary for a unit operation for containment purposes. Residence times are important parameters in a multitude of unit operations.

Among the most common processes associated with residence times are reactors and disengaging section of vapor-liquid and liquid-liquid separation vessels. In thin-gap modules, residence times are created by gaps and by porous media in plates. Residence times (relative to other unit-operation plates) are increased by increasing the thickness of gaps/gaskets (or extent of buildup of sealing perimeter section) or by increasing the thickness and/or porosity of the functional area in the plates. Structured packing may also be incorporated as part of the plate or as part of the gap—the structured packing my slightly decrease residence time compared to void volumes; however, the packing can facilitate plug-flow behavior or disengaging.

Heterogeneous Catalysis—For heterogeneous catalysis, the gap function is insignificant relative to the porous media containing catalytic abilities. Gaps between a series of plates can alleviate potential by-passing problems in plates by mixing streams between a series of plates.

The heterogeneous catalyst is preferably fastened to the plate, although, catalytic packing can be arranged in a fixed-bed arrangement in gaps. The ratio of thickness to width or thickness to length (flow is generally in the thickness direction) can be varied to meet residence time specifications. Preferably both of the said ratios are less than 1.0. Even more preferably, these ratios are below 0.4, and most preferably these ratios are less than 0.1; however, any ratios that are designed to allow face-to-face assembly are potentially viable—depending on the application.

Heterogeneous catalyst can be fastened to the plate or integrated into a plate by methods known in the art and science. These include commercial and research methods for creating porous material with high surface-to-volume ratios and distribution of catalyst-active sites throughout the porous material. Methods such as pressing catalyst materials into the psuedo-two-dimensional shape, gelling methods, sputtering methods, precipitation methods, and structured packing methods are a few of several of the methods known in the science and viable for this application. FIG. 11 illustrates three preferred modes of design of heterogeneous catalysis plates-optimal designs will depend upon application.

Generic catalyst support plates can be manufactured for later addition of a catalyst material onto the support by methods known in the science and art. Improved economies-of-scale are realized by mass production of generic support plates with later alteration to provide specific catalytic properties.

For both heterogeneous and homogeneous reactions, significant advantages of the plate design are realized for exothermic reactions. Whereas hot spots can form in conventional fixed-bed reactors during strongly exothermic reactions, exotherms they can be easily avoided in thin-gap modules by use of heterogeneous catalysis plates with low ratios of thickness to length/width. In thin-gap modules, conductive heat transfer can be readily designed to prevent reactor hot spots or exotherms—at a fixed residence time, plates can be designed with high thermal conductivity relative to the convective mass transfer for reactants. For homogeneous reactions a similar stability is realized with thin gaps or porous areas relative to widths/lengths.

Vapor-Liquid Separation—Conventional liquid-vapor separation processes are based on controlling temperature and/or pressure in a volume where residence times are sufficient to allow the vapor to disengage from the liquid phase. Similarly plate(s) and gap(s) designed to provide vapor-liquid separation would provide a residence time for disengagement. Some of the embodiments available for creating this residence time are a gap between plates, a structured packing that is either in a gap or part of a plate, non-structured pacing in a gap, or the porous media of a plate.

The width of the gap or packing is designed to provide the desired residence time. The interaction of the gap with structured packing (e.g. on the plate) and feed/exit locations on plates will largely determine the effectiveness of the plate. Packing and countercurrent flow will allow multiple stages of separation in gaps or packing designed for disengaging two fluid phases. The liquid entering at the top of the gap/packing or vapor entering at the bottom of the gap/packing can originate from another vapor-liquid embodiment in the module. Typically, these other vapor-liquid embodiments are operated at nearly the same pressure but at different temperatures. To assist liquid flow, the source of liquid reflux would be from a vapor-liquid separation embodiment located at a higher position in the module.

Alternative to the use of a reboiler and reflux condenser, heat exchange through the entire plate wall could be used to control the number of theoretical plates from the separation unit. This type of arrangement can promote far more efficient heat transfer then is possible with a reboiler or condenser operating at a nearly constant temperature-especially when the heat is being recovered from product stream introduced to an entering stream. Such heat transfer throughout an entire column is typically not practical with conventional distillation column designs. In this configuration, the hot bottom's product can be used to promote evaporation in the column at locations above the stage from which the bottom's product is removed.

The HETP decreases substantially as the space between plates decreases—this can lead to substantial reductions in equipment sizes.

A novel form of packing includes hanging plastic embodiments that create surface area. Such plastic is supported from above and is light weight.

Liquid-Liquid Separation—Similar design principles apply for liquid-liquid separation as for vapor-liquid separation per residence time requirements and how packing-enhanced surface area can improve separation. For liquid-liquid separation, the denser liquid is introduced at the top and the lighter liquid is introduced at the bottom of the respective embodiment.

Gap and Plate Thickness—For applications where the sole purpose of the gap is to separate plates, the gap thickness should be minimized since increasing gaps will increase residence times. For reactions, gaps can be used to provide reactor residence times and may be designed for this purpose with or without packing.

Residence times can be created by porous media incorporated into plates. Reducing plate thickness without reducing the effectiveness of the plate in performing the specified unit operation will lead to reduced costs. For heat transfer, the structural properties of a plate can rely on intermediate contact with neighboring plates thereby minimizing plate thickness for heat transfer applications. For these types of heat transfer applications, the plates could be many times thinner than the walls of conventional heat transfer surfaces.

Optimal Thickness of Plates—Unlike the walls of a vessel or the walls of a typical shell-and-tube heat exchanger, the walls of plates can rely on neighboring plates to provide structural support. Forces normal to the surface of a plate can be countered by contact with neighboring plates sequentially to the faces of the module or plates within the module capable of producing a counteracting force. In such arrangements, gaps between plates are filled with structured material to distribute forces evenly from one plate to the next. Alternatively, the structured support system can be locations of intermittent contact built into the plate design. In such arrangements, plate wall thickness can be reduced to levels an order of magnitude less than corresponding surfaces on conventional equipment.

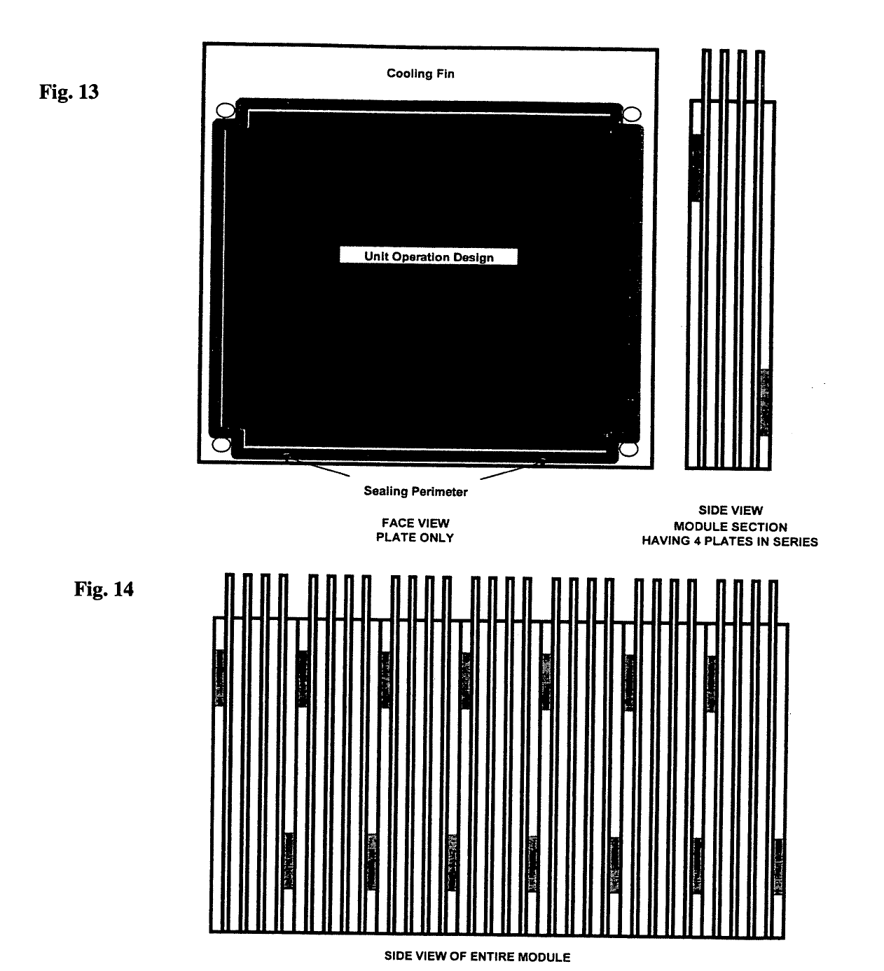

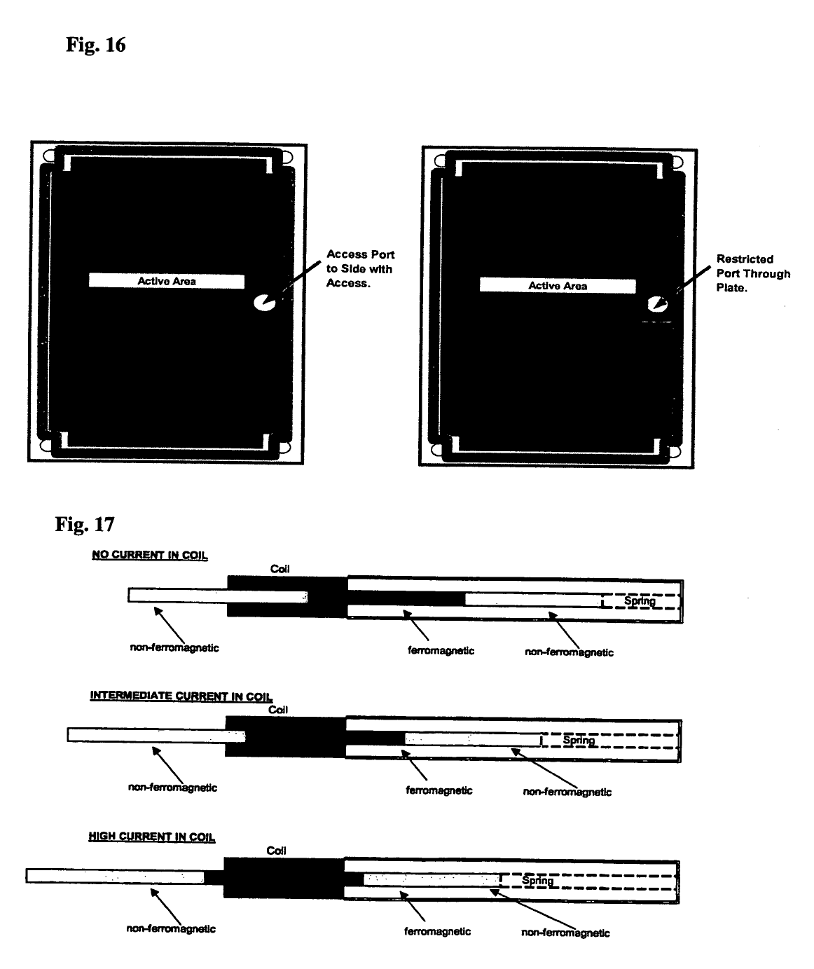

Internal Manifolding—FIGS. 9, 15, and 16 illustrate how cavities in plates or gaskets can be used to promote access to the functional parts of plates. FIG. 16 illustrates an embodiment of the present invention where holes in plates form passageways through a series of plates with access being allowed or restricted based on the absence or presence of a sealing surface around the hole at each gap and plate. This sealing or non-sealing criteria would be followed both on plates and gaskets between plates.

Minimizing Materials Costs—The design of thin-gap modules is based on a philosophy promoting mass production capabilities that incorporate pressing/stamping, injection molding, and printing methods. Since these methods have substantially less manufacturing costs per mass of material processed than fabrication/construction approaches, the thin- gap module creates opportunities to reduce total capital costs. Since the modules would be prefabricated, additional savings would be realized.

By reducing material costs in addition to manufacturing costs, capital costs could be further reduced. The thin-gap module approach presents the following methods of reducing materials costs: (1) eliminating piping between unit operations within a process, (2) eliminating the use of heat exchange fluids by placing unit operations next to each other in modules, (3) using thinner surfaces since structural requirements of inner walls are minimal, (4) eliminating the possibility of hot spots by incorporating improved conductive heat transfer capabilities, and (5) easy integration of cooling fins in the design to allow elimination of cooling water and cooling water towers in some applications. In the progression of optimizing benefits by minimizing materials costs, an additional design philosophy is set forth:

Optimal plate sizes and designs are at least an optimum where increasing plate dimensions lead to increased manufacturing costs per plate while decreasing plate sizes lead to increasing materials costs per plate and potentially lower barriers to heat transfer

Per this design criteria, preferred designs minimize materials associated with sealing surfaces between plates and in so doing maximize the ratio of volume used to promote residence relative to total mass of the module. In some instances this is better described as minimizing the volumes of porous and structured materials relative to sealing surfaces. To meet these objectives, preferred embodiments use sealing surfaces with a minimum reasonable area to achieve the seals without compromising safety or risk minimization. Areas outside the sealing perimeters are also minimized with the exception of cooling fins that are designed by methods known in the science and art. When imbedding porous media into a plate frame leads to lower material costs without compromising performance, this approach is preferred over placing the porous media on a perforated plate.

Dual-Purpose Parts—Another method of substantially reducing materials costs is to use parts serving two purposes. One example of a component serving two purposes is the porous catalyst support imbedded in a plate frame where this support provides sites for heterogeneous reactions and acts as piping for the transport from one gap to the next. In some applications it is preferred to have catalyst support with imbedded channels for heat transfer to a fluid traveling in the channels and where catalytic metals/oxides are placed on heat transfer surfaces thereby allowing these surfaces to serve two purposes.

When heat exchange is used to promote vapor-liquid separation, the preferred approach is to use a plate between the fluid undergoing vapor-liquid separation and the fluid that is providing or removing heat whereby the said plate provides both a surface for heat transfer and a structure promoting vapor-liquid contact for the separation process. One method for achieving this is to press dimples in this plate where the dimples extend substantially into the gap promoting vapor-liquid separation. To contain the other side of the fluid providing/removing heat from the vapor-liquid separation process, preferred embodiments use a dimpled plate that largely matches the contour of the first dimpled plate so as not to create relatively large volumes of fluid between the plates.

Module Section Sequencing—Modules sections containing multiple unit operations that cumulatively comprise a chemical process or subsection of a chemical process are preferably combined, face-to-face in series. Two possible configurations for this arrangement are head-tail-head-tail-head-tail-head-tail (head-tail) and head-tail-tail-head-head-tail-tail-head (head-head). For two sections containing similar vapor-liquid separation unit operations, it is preferred to have heat added/removed from these processes by a common fluid. If the head-tail-tail-head-head-tail-tail-head configuration leads to the ability to use a common fluid for heat transfer, the head-head configuration is preferred over the head-tail configuration. Based on temperature profiles alone, the head-head configuration is preferred over the head-tail configuration.

The sequencing of unit operations of two module sections, in general, benefit from the head-head configuration over the head-tail configuration.

For plates with flow, in general, normal to the face of the plate and dispersed evenly along the plate surface, the plates are preferably arranged in the order that the fluid contacts the modules to perform the desired chemical process. Examples of unit operation reactors with flow, in general, normal to the face of the plate are the reactor plates of FIG. 11.

For plates where flow into or out of the plate is not, in general, evenly distributed normal to the plate surface and throughout the plate, sequencing of plates in a module section in the order at which the fluid contacts the unit operations is not preferred. Preferred are embodiments where two or more unit operation sections are integrated to minimize plates and promote adjacent location of the same unit operations of different module sections. The head-head configuration is an example of this when the vapor-liquid separation is the last process in a series of unit operations. If vapor-liquid separation is in the middle of the sequence of unit operations in a process, a more integrate combination of two sections is preferred so as to promote configurations in the order [vapor-liquid separation gap]-[fluid of heat addition/removal gap]-[vapor-liquid separation gap]. An example of a plate were flow into or out of the plate is not, in general, evenly distributed normal to the plate surface and throughout the plate is a plate adjacent to a vapor-liquid separation gap/packing where bottoms product is typically removed at the bottom of the plate, overhead product is typically removed at the top of the plate, and feed is typically introduced at an intermediate location.

For some applications, it will not be optimal for all the plates to be designed for the same capacity. Through the networking made possible with the ports of FIG. 16, modules can be conveniently designed so that a high capacity plate can serve several low capacity plates.

When going from a sequential arrangement of plates to arrangements where otherwise separation sections of separate unit operations are integrately coupled, the complex networking/routing of flows may increase the portions of plates used as ports. Optimum configurations maximize plate area use for unit operation purposes while allowing enough networking of flows to minimize the number of plates and match preferred operating temperature profiles of adjacent plates.

The preferred means of insulation from heat losses is to locate plates with similar temperature profiles next to each other.

Generic Plate Parts—Most chemical processes are comprised, to a large extent, of similar unit operations. For traditional construction, the columns, reactors, etc . . . are individually built, and so, advantages of having similar unit operations are actually minimal. However, since plates would be mass-produced, significant advantages could be realized by using the same plate in different chemical process modules. In the most preferred embodiments of this invention, standards on plate lengths and widths are set so unit operation plates are largely interchangable between different processes. This avoids the redesign of plates and capitalizes on mass production economics. Furthermore, when new plants are specified and built, they could possibly be fabricated by combining already-designed plates with minor modifications to plates. The sequencing specifics of plates would tend to be more specific to a process than many of the plates.

Safety and Environmental Impact—The thin-gap module approach to chemical process design significantly minimizes risks of incidents that impact safety and the environmental. An important component of the approach is that arrays of modules can be easily located in buildings that would enclose emissions and contain spills. The modules are simply much more compact than the spread-out nature of chemical processing plants that are designed to provide access for people, equipment and instrumentation. In addition, the low chemical inventories of modules are synonymous with reduced risk. In addition, since the modules are designed in a compact/block configuration, complex access routes are avoided.

Capacitor Plates—Sections of plates or entire plates in a module can be insulated from electrical flow and charged. The face-to-face arrangement allows for improved capacitance between plates. Voltage charges and benefits thereof are made more convenient and useful in these configurations. Likewise, processes relying on voltage charges are made easier and more convenient in this relationship. These plates can be insulated from the fluid flowing through the process, can be in contact with the fluid flowing through the process, or can create charge gradients on a third plate located between two capacitor plates. The advantage of a charge gradient on a third plate is that charges are realized without current flow in the fluid (if the fluid contacting the third plate is electrically conductive).

Module Maintenance—Preferably, thin-gap modules are designed with a specific life expectancy, possibly that of the catalyst, and then disposed of after that period. If maintenance is needed, the preferred form of maintenance with a mobile robotic device designed to follow the module along a track-type device and to automatically evaluate sections of the module. If module sections are not functioning correctly, a robotic device would alter the failing sections so as to cause these sections to be by-passed and not used in the integrated production scheme.

The preferred methods of reducing maintenance consists of (1) improving system reliability, (2) improving system repeatability, (3) over-designing of those plates likely to have decreases in efficiency, (4) improving the reproducibility of module section fabrication, and (5) quality control of all influent streams to the module.

Process Control—Almost every aspect of science and engineering relies on repeatability of processes and experiments. One of the few exceptions to this approach has been the traditional approach to process control. For example, rather than metering in the exact same quantity of steam to a process to maintain temperatures, a feedback control method is typically used to control the flow rate of steam to a unit operation. For additional example, rather than having a valve set at the exact same position at all times of operation to control flow rates, flow rates or another downstream variable is measured and used with feedback control means to control the position of the valve. The temperature and sometimes pressure and composition of feed streams are allowed to vary with feedback control means being used to compensate for varying feed compositions.

It is not that the concept of system repeatability does not work for chemica! processes, but rather, for large chemical processes comprised of large unit operations it is more cost effective to use a feedback control system then it is both to 20 maintain higher quality on all materials entering the chemical production process and to proactively identify the settings of all the valves or other control means.

In thin-gap modules, the preferred means of control is to (1) develop robust plate-based unit operations that have a range of stable operation, (2) maintain improved quality control on all influent streams to the module, (3) maintain improved repeatability/quality control on all plates and modules, and (4) over-design those plates that are most likely to introduce deviation and out-of-spec product. To assist with quality control of influents, heat exchangers are used prior to the module to assure the influents go in at the same temperature when the module operation is sensitive to influent temperatures.

Influent pressures are also used both to control the quality of product produced, and in some instances, the quantity of product produced. All streams are preferably free of solids so solids do not accumulate in modules-filtering influents can correct problem streams.

When operating in the preferred mode of repeatable performance, all streams entering modules should experience similar resistance to flows. For traditional unit operations, resistance to flow created by restrictions in valves is used to control flow rates. In modules, a variety of methods are available to create similar resistance to flows, including (1) high repeatability of resistance through all plates in the module (especially those porous or membrane plates creating the highest resistance) and (2) introduction of restrictive passageways (valve-type-restrictions) of module process sections that introduce a very high repeatable resistance to all flows. These valve-type devices are preferably located upstream from any components susceptible to have small pieces break free and plug restrictions in lines. The flow control means would apply to reactants entering processes as well as steam or fuel used for heating.

For processes requiring the mixing of streams at critical stoichiometries, preferred modes of operation include mixing streams before entering modules if premixing reactants does not adversely impact module operation.

Advanced modules would incorporate electrical circuits into plate designs, flow can be controlled by incorporation of appropriate resistances in the flow paths. Development opportunities exist for incorporating smart materials and simple integrated control circuits and valves. Smart materials include those that expand or contract in response to temperature changes or electrical current. Smart resistors would automatically reduce heat output at higher temperatures and increase heat output at lower temperatures and would be designed to facilitate operation at set point temperatures. These devices can be incorporated into module design by methods known in the science as these materials become available.

Over-design of module components is not necessarily a waste of resources, since during typical operation, an over-designed module may produce more product within specification than a module designed that is not over-designed.

An optional embodiment for control of resistances is to incorporate small valves into flow paths. These valves can be controlled by smart materials and/or electrical circuits built into the plates. Alternatively, these valves can be controlled exterior to the process by known electronic means or by manual or robotic means. In some instances access to a needle-type valves would be with an alien wrench so as to restrict adjustments to specific (initial) or periodic procedures. These allen-wrench-type access points for valves could be sealed with plastic or solder between adjustments to minimize leakage.

Elimination of Auxiliary Equipment—While the previous examples illustrated the elimination of separate unit operation vessels by strategic locations of membrane walls and fluid flows; auxiliary equipment such as compressors, thermocouples, and power supplies can also be incorporated under special circumstances.

Miniature Thermocouples—The preferred approach to the monitoring of internal temperatures would be the incorporation of miniature thermocouples into the design of the pseudo two-dimensional plates. In advanced concepts, integrated electrical circuits with thermocouple embodiments are on or in the plates.

Fuel-Cell Incorporation—Fuel cell activity can be incorporated as one of many pseudo two-dimensional plates in the modules independent of whether electrical energy production is the primary purpose of the module. The plates can be used to convert by-products to useful electricity or to produce electricity that is needed by a different plate in the module.

Miniature Heaters—Electrical heaters would be no more practical for sustained operation in a modular unit than they would be for large processes—the cost of electricity is simply too high compared to natural gas. However, the use of electrical heaters during the dynamic startup phases of operation or as supplementary control measures is practical and prudent. Also, electrical heaters can be used to provide incremental changes in temperature as a fine-tuning and easier-controlled method to achieved desired operating conditions. Resistive heaters can be incorporated as part of plates for this application.

Electrochemical Compressors—In addition to known electrochemical reactions, electrochemical processes can also be used to provide compressed gases. For example, ion-conductive membranes can be used to transport oxygen from ambient atmosphere to a highly purified form within a module at a higher partial pressure than atmospheric oxygen.

Economy-of-scale—One of the major factors that limits the economics of parallel trains in chemical production are the costs of piping and instrumentation that not increase substantially with scale-up, and so, three trains translates to close to three times the piping and instrumentation costs. For the module approach, most of the piping and instrumentation is eliminated. That which remains is designed for quick connection and minimal costs.

In theory, the quick startup times and tailoring of capacities could allow for the elimination of product storage for some applications-leading to further reductions in cost. The system would also be susceptible to automation. The economic advantages of startup times in the order of a few seconds and complete system automation should not be overlooked and can be immense. Startup could be as simple as initiating flow of influents and to the process, but might include closing electrochemical circuits or activation of heating elements built into the module-depending on the application.

Miscellaneous—For high capacity or large volume processes, thin gap technology would rely on the mass production of unit-operation-specific plates that are assembled to provide an integrated process in a module section. However, this does not preclude the possibility of using plates that have the ability to perform multiple unit operations due to layering. The plates and/or gaskets between the plates establish flow patterns. Devices such as thermocouples can be integrated directly into the plates. The plates are referred to as pseudo two-dimensional plates since their thickness is quite small in comparison to their length and width.

Thin-gap modules are designed with the following design goals:
Easy assembly of plates to modules.
Easy combination of modules to meet high production rates.
Minimum use of materials beyond catalysts and heat transfer areas that are absolutely necessary.
Flow patterns that provide desired residence times and distributions and heat transfer.

A development goal is that the total materials/metals needed for a modular plant would be less than needed for a conventional plant. This reduction could be achieved due to elimination of pipes and thinner materials for heat transfer processes.

Catalyst Plate Fabrication & Characterization—The goal of catalyst plate fabrication is to bind catalysts/supports to a plate such that the following operational constraints are met: .

Flow is uniform through the plate in a direction perpendicular to the plate surface.

Residence time in plate can be varied by varying pressure gradients and by varying the thickness of the plates. Approaches are needed for residence times varying from a few microseconds to 5 seconds to 5 minutes.

The primary resistance to flow could reside in either the plate/membrane or the catalyst support.

Methods used to form small structures such as pellets that are currently used in packed bed reactors are preferably used on a larger scale to form larger structures of shapes and relative dimensions as indicated by FIG. 11.

### ILLUSTRATIVE EXAMPLES

In this example, the battery pack has a 10-mile capacity, the hydrogen tank has a 10-mile capacity, and the miles of capacity are indicated for the battery pack and hydrogen tank. The following table shows how the combination of a battery pack and fuel cell battery charger can cost less than the battery pack alone or a fuel cell stack alone to provide the 40 miles of capacity per daily cycle.

Cost assumptions:
Battery-$300 for 10 miles range
Fuel Cell-$500 for 2 kW
40 mile range and 50 kW
Neglect cost of tanks

BEV (battery electric vehicle): 4×$300=$1,200
FCEV (fuel cell electric vehicle): 25×$500=$12,500
PEV-FCBC: $300+$500=$800

The following is a different example under different assumptions:
Cost Assumptions:
   Battery-$300 for 10 miles range
   Fuel Cell-$500 for 2 kW
   100 mile range and 50 kW
BEV: 10×$300=$3,000
FCEV: 25×$500=$12,500
PEV-FCBC: $300+3×$500=$1,800

Note that is both of these examples the PEF-FCBC cost is less than either batteries alone or fuel cell stack alone to provide the indicated commute range.

The preferred fuel cell battery charger power output is related to the capacity of stored hydrogen and oxygen. The preferred capacity in kW is about: [miles range of stored hydrogen/oxygen]/[10 hours]×[kW needed to power vehicle at about 1 mile per hour]
For example: a 100 mile range tank/10 hours X 0.666 kW/mph=6.66 kW
Where the 0.666 kW/mph is specific to the vehicle.

In terms of range the equation preferably includes division by 3 to 12 hours and more preferably by 4 to 10 hours and most preferably about 10 hours. Restating the equation:
FCPW=Const. X HTC and if FCPW>20 kW, FCPW is set equal to 20 kW.

Where: FCPW is fuel cell battery charger maximum power rating in kW and HTC is the hydrogen tank capacity in miles of travel per the average in-city fuel economy rating. The constant is between 0.222 and 0.0555 kW/mile. For the hydrogen tank with 100 miles capacity, this translates to 20 (22.2 set down to 20) to 5.55 kW.

1. A power supply for a plug-in hybrid electric vehicle consisting of
a battery pack capable of providing a power output between 20 and 1000 kW,
a fuel cell capable of providing a power output between 0.2 and 20 kW,
a hydrogen fuel tank with a rated capacity rated in miles of travel at an average city fuel economy rating where the rated capacity in miles is equal to between 4.5 and 18 times the fuel cell maximum power rating in kW, and
a control means that utilizes the power output of the battery pack to provide the high power needs of the vehicle and uses the fuel cell as a battery charger to charge the battery pack.

2. The power supply of claim 1 where
the power output of the battery pack is between 20 and 200 kW and the power output of the fuel cell battery charger is between 0.5 and 10 kW.

3. The power supply of claim 1 where
the power output of the battery pack is between 40 and 100 kW and the power output of the fuel cell battery charger is between 1.5 and 5 kW.

4. The power supply of claim 1 with a backup internal combustion engine.

5. An improved fuel cell power system using an air separator to supplement a stored electrolysis oxygen supply consisting of
a pressurized regenerative fuel cell capable of producing hydrogen through hydrolysis of water and producing electrical power through electrochemical reactions of oxygen and a fuel,
an electrolysis oxygen tank capable of storing between 0.2 and 100 kilograms of oxygen,
an air-separated oxygen tank capable of storing between 0.2 and 100 kilograms of oxygen,
an air separator capable of separating air into at least one oxygen stream having a purity of at least 50 wt % oxygen,
a hydrogen storage tank,
a liquid fuel storage tank containing a liquid fuel, and
a control means that directs the utilization of at least 70% of the stored hydrogen and stored electrolysis oxygen before switching to the use of air-separated oxygen and liquid fuel where
the pressurized regenerative fuel cell is capable of operating at pressures greater than 5 bars of pressure.

6. The system according to claim 5 where
the control means increases the rate at which stored oxygen is supplied to the fuel cell as a means to increase power output.

7. The system according to claim 5 where
the fuel cell is capable of being fueled by hydrogen, the liquid fuel, or a combination of hydrogen and the liquid fuel.

8. The system according to 7 where the liquid fuel is a short chain alcohol.

9. The system according to 8 where the liquid fuel is comprised of methanol, ethanol, or a mixture of methanol and ethanol.

10. The system according to 5 where the liquid fuel is converted to hydrogen prior to use by the fuel cell.

11. The system according to 5 where the air separator is a membrane system comprised of at least one membrane and at least one compression means.

12. The fuel cell power system according to claim 5 where the regenerative fuel cell is a stack comprised of at least two groupings of fuel cells where the groupings are connected in series wherein,
each fuel cell group has a cathode entrance for an oxidant to enter the fuel cell and a cathode exit that purges inert gases from the fuel cell,
where the oxidant enters the cathode entrance of a first fuel cell group, and a first fuel cell group cathode purge exits the first fuel cell group and enters the cathode entrance of a second fuel cell group and where the this sequential flow proceeds from the first fuel cell group to the last fuel cell group.

13. The fuel cell power system according to 12 where the last fuel cell group has a higher ratio of mass of catalyst to surface area of membrane than the first fuel cell group.

14. The fuel cell power system according to 12 where a recycle stream connects the cathode exit of the last fuel cell group to the air separator where oxygen in the recycle stream is separated in the air separator and is returned to the fuel cell group.

15. A regenerative fuel cell system consisting of
a pressurized regenerative fuel cell capable of producing hydrogen through hydrolysis of water and producing electrical power through electrochemical reactions of oxygen and a fuel,
a pressurized electrolysis oxygen tank capable of storing between 0.2 and 100 kilograms of oxygen and having a oxygen tank volume consistent with storing the oxygen at a pressure between 50 and 500 bars of pressure,
a pressurized hydrogen storage tank capable of storing between 0.025 and 12.5 kilograms of hydrogen and having a hydrogen tank volume consistent with storing the hydrogen at a pressure between 50 and 500 bars of pressure
where the ratio of the volume of the hydrogen tank to the oxygen tank is between 1:1.6 and 1:2.1,
a line with one end connecting the bottom of the hydrogen tank and a second end connected to the oxygen tank where
the line is filled with a liquid that freely flows between the two tanks and equilibrates the pressures of the two tanks.

16. The regenerative fuel cell system of claim 15 where the liquid is water.

17. The regenerative fuel cell system of claim 16 including
a second line with one end connected to the oxygen tank and the second end connected to the entrance of a pump and
a third line with one end connected to the exit of a pump and a second end connected to the cathode side of the fuel cell
a monitoring and control means that pumps the water from the oxygen tank to the cathode side of the fuel cell to flood the cathode side of the fuel cell and allows electrolysis generation of oxygen and hydrogen by the fuel cell.
